(19) United States
(12) Patent Application Publication
(10) Pub. No.: US 2007/0288925 A1
(43) Pub. Date: Dec. 13, 2007

(54) Arrangements, Methods, and Software for Managing Objects and Resolving Different Types of Events Associated with Such Objects

(75) Inventors: Brian Hughes, Round Hill, VA (US); Randy Charles Jones, Jacksonville, FL (US); Piers McMahon, New York, NY (US); Joseph Offenberg, Staten Island, NY (US); Peter Skotny, Norton, MA (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 11/695,873

(22) Filed: Apr. 3, 2007

Related U.S. Application Data
(60) Provisional application No. 60/744,256, filed on Apr. 4, 2006.

(51) Int. Cl. G06F 9/46

(52) U.S. Cl. 718/100

(57) ABSTRACT

An arrangement for resolving different types of events includes a central system communicatively coupled to each of a plurality of lower level systems. The central system is configured to receive information associated with a particular event from one of the plurality of lower level systems, to determine an event type associated with the particular event, and to determine whether the central system includes a particular policy associated with resolving the event type associated with the particular event. When the central system includes the particular policy, the central system is further configured to resolve the particular event in accordance with the particular policy. Moreover, when the central system does not include the particular policy the central system is further configured to request information associated with the particular policy, to receive the information associated with the particular policy, to resolve the particular event in accordance with the particular policy, to store the particular policy in a database, and to resolve future events that are of the event type associated with the particular type of event in accordance with the particular policy.

The present invention claims priority from U.S. Provisional Patent Application Ser. No. 60/744,256, which is entitled “Arrangements, Methods, and Software for Managing Objects and Resolving Different Types of Events Associated with such Objects,” and was filed on Apr. 4, 2006, the disclosure of which is incorporated herein by reference in its entirety.

### BACKGROUND OF THE INVENTION

1. Field of the Invention

The present invention is related generally to arrangements, methods, and software for managing objects and for resolving different types of events associated with such objects. In particular, the present invention is directed towards arrangements, methods, and software in which in a central system is configured to resolve different types of events in accordance with predetermined policies, and to dynamically receive new policies and/or update existing policies.

2. Description of Related Art

Information technology plays a substantial role in managing operational and business risks, and in ensuring that organizational assets are protected and compliance with pertinent regulations may be satisfied while ensuring continuity of on-going information technology operations that support the organization. Information technology organizations are under substantial pressure to more effectively manage information technology operational and capital costs. While managing costs, information technology organizations also are being asked to increase the level of service being delivered to the business and to respond quickly to business change, often times with no additional budget. Moreover, information technology needs to add value to the business to help fuel corporate growth by aligning investments in a manner that supports new business incentives and ensures that the business's most critical processes are working effectively and efficiently. Nevertheless, a substantial portion of the information technology organizations today spend upwards of 70% of their total budget maintaining the day-to-day operations of the business, which substantially reduces the information technology organization's opportunity to proactively anticipate business needs or to innovate.

To succeed in today's business environment, businesses need to offer services that are comparable or better than their competition. Banks, retail stores, and even utility companies need to provide fast service in their stores and on their web sites. If their services are slow or unavailable, customers will quickly look for alternatives. The operations staff needs to ensure that the business services are available and are providing acceptable performances. To meet these objectives, tools are installed to monitor the health of the information technology environment and processes are defined to assist in resolving problems that arise. Examples of the types of tools that may be installed include agents to monitor operating systems, business critical applications such as SAP (systems, applications, processes), PeopleSoft, and Seibel, tools to prevent intruders from gaining access to the business environment and sensitive information that could compromise the security or the reputation of the business, trouble ticking systems to assist with problem notification and problem management, asset management tools to provide important information about devices that owned, and the like.

Generally, agents, tools, and processes are implemented in a disparate manner over several years, and create several challenges for operations managers. For example, software agents and devices generate a large number of trivial and non-trivial events. These events are transmitted to several different consoles depending on the type of device, the software agent, or the device location. This requires the staff to monitor multiple consoles and to manually filter the critical events from the trivial events. Manual processes may be time consuming and prone to error. Moreover, events may be transmitted from non-managed sources and may create extra work for the operations staff, e.g., the operation staff may need to determine the source and the location of the event. In addition, there is no correlation to understand how incoming events may be related, and there is not a system that allows for reporting with respect to these events on a regular basis. This prevents the operations staff from proactively managing the environment and identifying and resolving potential problems before they occur. The combination of the above-described information technology issues causes the operations staff to be ineffective and slow to identify and resolve problems that directly affect the business, and requires additional staff members to monitor and mange the environment.

### SUMMARY OF THE INVENTION

Therefore, a need has arisen for arrangements, methods, and software that overcome these and other problems associated with the related art. The present invention presents a new approach for managing information technology. The present invention is service oriented in it's approach to flexibly manage across the entire business and at the same time provides the agility to manage from the information technology infrastructure level up to the business process. The present invention enables information technology organizations to overcome the fragmentation and complexity challenges associated with managing information technology, and provides a model for unifying and simplifying the management of information technology in order to realize the full potential of information technology. For example, the present invention may provide a layer of abstraction for business information technology that is service driven and overcomes complexity issues, thereby allowing information technology infrastructure to be tied to business processes. The present invention also may integrate information technology management with a consistent approach across security systems, storage systems, node or server systems, network systems, application systems, and the like, and supports open standards and connectivity. Moreover, the present invention may provide a vendor-neutral, independent approach to information technology management.

According to an embodiment of the present invention, an arrangement for resolving different types of events comprises a central system communicatively coupled to each of a plurality of lower level systems. The central system is configured to receive information associated with a particular event from one of the plurality of lower level systems, to determine an event type associated with the particular event, and to determine whether the central system comprises a particular policy associated with resolving the event type associated with the particular event. When the central system comprises the particular policy, the central system is further configured to resolve the particular event in accordance with the particular policy. Moreover, when the central system does not comprise the particular policy the central system is further configured to request information associated with the particular policy, to receive the information associated with the particular policy, to resolve the particular event in accordance with the particular policy, to store the particular policy in a database, and to resolve future events that are of the event type associated with the particular type of event in accordance with the particular policy.

According to another embodiment of the present invention, a method for resolving different types of events, in which a central system is communicatively coupled to each of a plurality of lower level systems, comprises the steps of receiving information associated with a particular event from one of the plurality of lower level systems, and determining an event type associated with the particular event. The method also comprises the steps of determining whether the central system comprises a particular policy associated with resolving the event type associated with the particular event, and when the central system comprises the particular policy, resolving the particular event in accordance with the particular policy. Nevertheless, when the central system does not comprise the particular policy, the method comprises the steps of requesting information associated with the particular policy, receiving the information associated with the particular policy, resolving the particular event in accordance with the particular policy, storing the particular policy in a database, and resolving future events that are of the event type associated with the particular type of event in accordance with the particular policy.

According to yet another embodiment of the present invention, a software arrangement which, when executed by a processing arrangement associated with a central system communicatively coupled to each of a plurality of lower level systems, is configured to perform the steps of receiving information associated with a particular event from one of the plurality of lower level systems, and determining an event type associated with the particular event. The software arrangement also is configured to perform the steps of determining whether the central system comprises a particular policy associated with resolving the event type associated with the particular event, and when the central system comprises the particular policy, resolving the particular event in accordance with the particular policy. Nevertheless, when the central system does not comprise the particular policy, the software arrangement is configured to perform the steps of requesting information associated with the particular policy, receiving the information associated with the particular policy, resolving the particular event in accordance with the particular policy, storing the particular policy in a database, and resolving future events that are of the event type associated with the particular type of event in accordance with the particular policy.

According to still another embodiment of the present invention, an arrangement for managing objects and for resolving different types of events associated with the objects comprises an operations management system. The operations management system is configured to select a particular object to be managed by the arrangement, to determine an object type associated with the particular object, and to associate an event selection policy with the particular object based at least on the object type associated with the particular object, in which the event selection policy indicates at least one event type that is associated with the particular object. The operations management system also is configured to selectively associate an agent with the particular object, in which the agent is associated with one of a plurality of lower level systems. The arrangement also comprises a central system communicatively coupled to the operations management system and to each of the plurality of lower level systems. The central system is configured to receive information associated with a particular event from one of the plurality of lower level systems, in which the particular event originates from the particular object, and to determine an event type associated with the particular event. The central system also is configured to determine whether the central system comprises a particular policy associated with resolving the event type associated with the particular event. Moreover, when the central system comprises the particular policy the central system is further configured to resolve the particular event in accordance with the particular policy. Nevertheless, when the central system does not comprise the particular policy the central system is further configured to request information associated with the particular policy, to receive the information associated with the particular policy, to resolve the particular event in accordance with the particular policy, to store the particular policy in a database, and to resolve future events that are of the event type associated with the particular type of event in accordance with the particular policy.

According to still yet another embodiment of the present invention, a method for managing objects and for resolving different types of events associated with the objects, in which a central system is communicatively coupled to an operations managing system and each of a plurality of lower level systems, comprises the steps of selecting a particular object to be managed by the arrangement, and determining an object type associated with the particular object. The method also comprises the steps of associating an event selection policy with the particular object based at least on the object type associated with the particular object, in which the event selection policy indicates at least one event type that is associated with the particular object, and selectively associating an agent with the particular object, in which the agent is associated with one of a plurality of lower level systems. The method further comprises the steps of receiving information associated with a particular event from one of the plurality of lower level systems, in which the particular event originates from the particular object, an determining an event type associated with the particular event. The method further comprises the step of determining whether the central system comprises a particular policy associated with resolving the event type associated with the particular event. When the central system comprises the particular policy, the method also comprises the step of resolving the particular event in accordance with the particular policy. Nevertheless, when the central system does not comprise the particular policy, the method further comprises the steps of requesting information associated with the particular policy, receiving the information associated with the particular policy, resolving the particular event in accordance with the particular policy, storing the particular policy in a database, and resolving future events that are of the event type associated with the particular type of event in accordance with the particular policy.

Other features and technical advantages of the present invention will be apparent to persons of ordinary skill in the art in view of the following detailed description of the invention and the accompanying drawings.

### BRIEF DESCRIPTION OF THE DRAWINGS

For a more complete understanding of the present invention, the needs satisfied thereby, and the features and technical advantages thereof, reference now is made to the following descriptions taken in connection with the accompanying drawings.

FIG. 1 is a schematic of an arrangement for resolving different types of events, according to an embodiment of the present invention.

FIG. 2 is a flow chart of a method for resolving different types of events, according to an embodiment of the present invention.

FIG. 3 is a schematic of an arrangement for managing objects and for resolving different types of events associated with the objects, according to an embodiment of the present invention.

FIG. 4 is flow chart of a method for managing objects and for resolving different types of events associated with the objects, according to an embodiment of the present invention.

FIGS. 5a and 5b are flow charts of a method for managing objects, according to an embodiment of the present invention.

FIGS. 6a and 6b are flow charts of a method for managing objects, in which the embodiment of the present invention depicted in FIGS. 5a and 5b are modified.

FIGS. 7a and 7b are flow charts of a method for managing objects, in which the embodiment of the present invention depicted in FIGS. 6a and 6b are modified.

FIGS. 8a and 8b are flow charts of a method for managing objects, in which the embodiment of the present invention depicted in FIGS. 7a and 7b are modified.

FIG. 9 is a flow chart of a method for resolving different types of events, according to an embodiment of the present invention.

FIG. 10 is a flow chart of a method for resolving different types of events, in which the embodiment of the present invention depicted in FIG. 9 is modified.

FIG. 11 is a flow chart of a method for resolving different types of events, in which the embodiment of the present invention depicted in FIG. 10 is modified.

FIG. 12 is a flow chart of a method for resolving different types of events, in which the embodiment of the present invention depicted in FIG. 11 is modified.

FIG. 13 is a flow chart of a method for reporting data associated with managed objects and events associated with such managed objects, according to an embodiment of the present invention.

FIG. 14 is a flow chart of a method for reporting data associated with managed objects and events associated with such managed objects, in which the embodiment of the present invention depicted in FIG. 13 is modified.

FIG. 15 is a flow chart of a method for reporting data associated with managed objects and events associated with such managed objects, in which the embodiment of the present invention depicted in FIG. 14 is modified.

FIG. 16 is a flow chart of a method for reporting data associated with managed objects and events associated with such managed objects, in which the embodiment of the present invention depicted in FIG. 15 is modified.

### DETAILED DESCRIPTION OF EMBODIMENTS

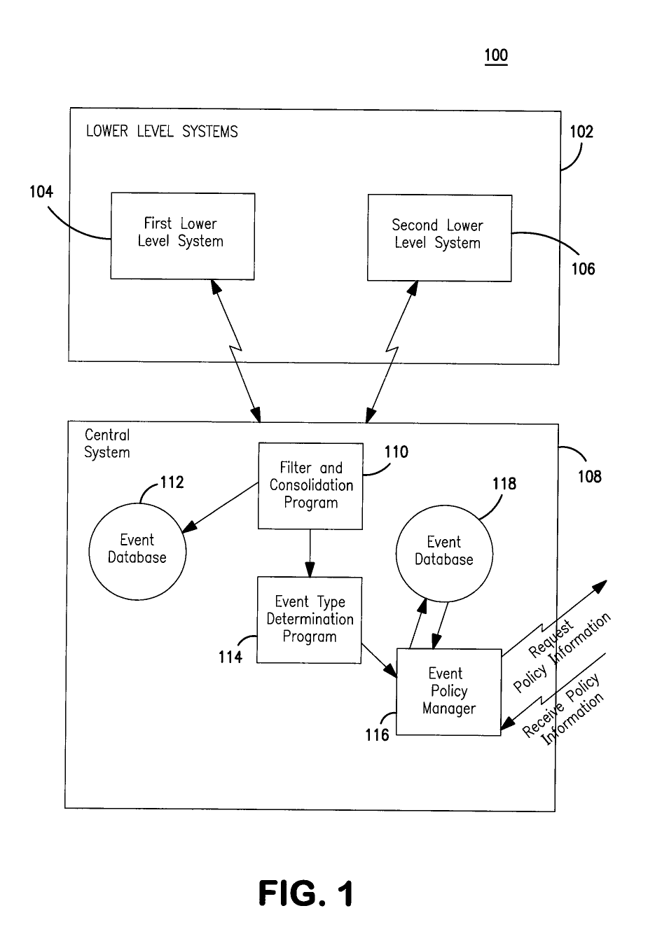

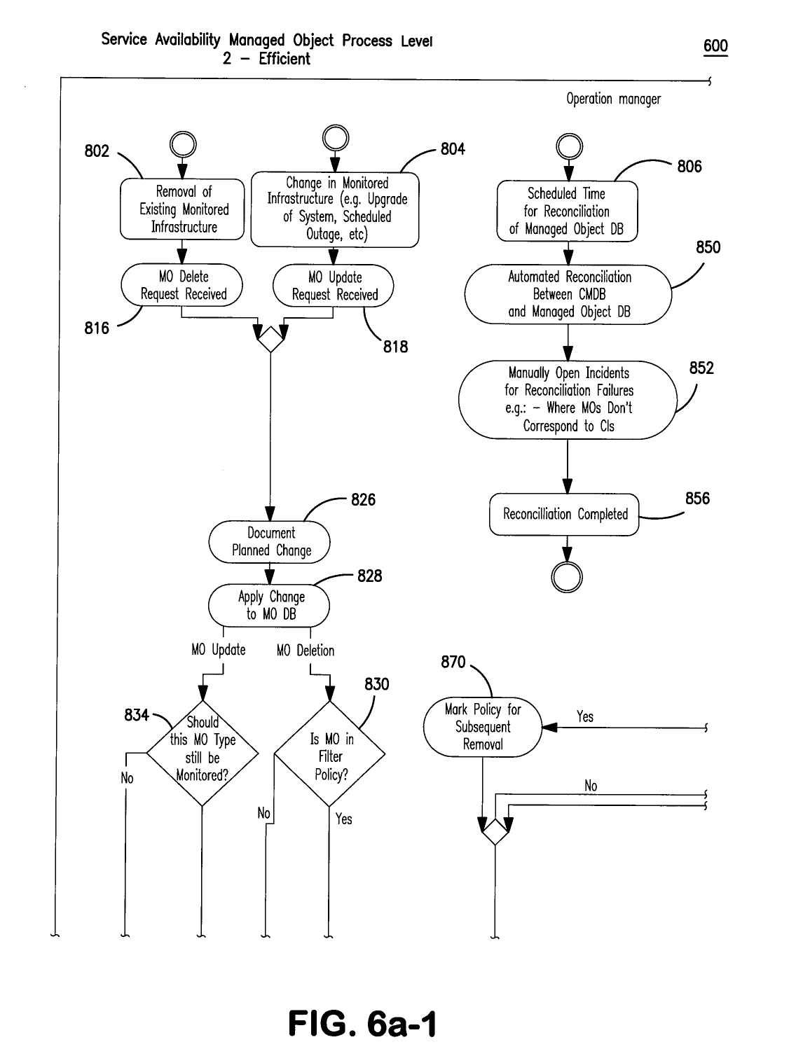

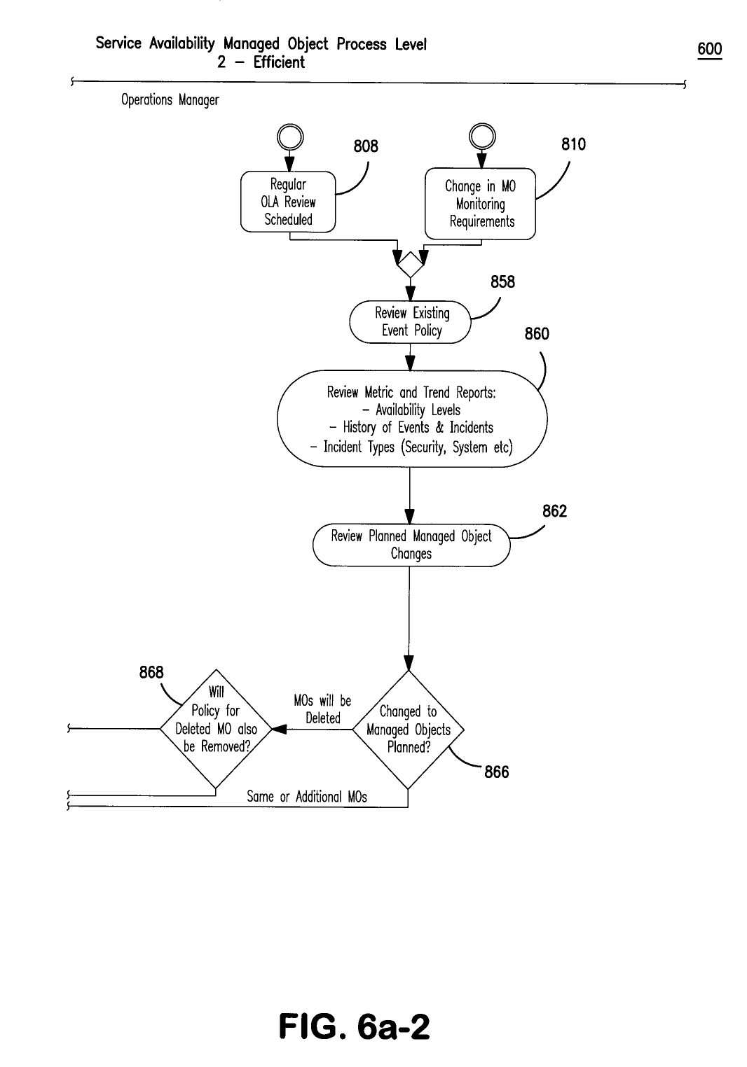

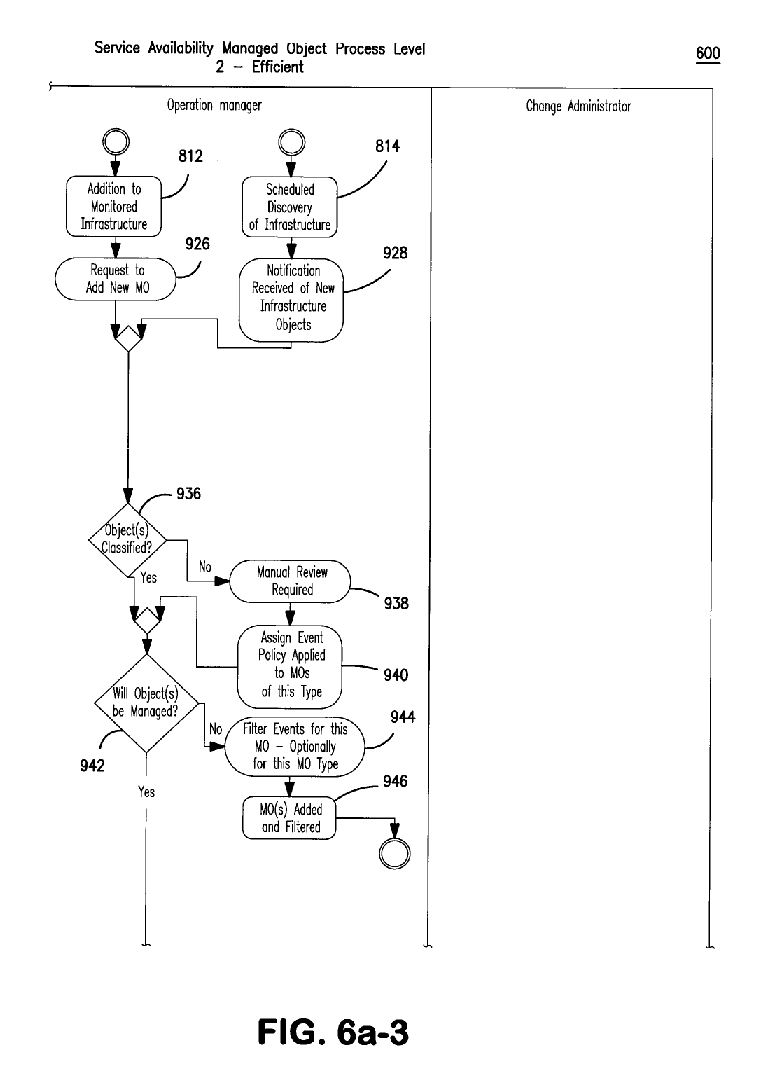

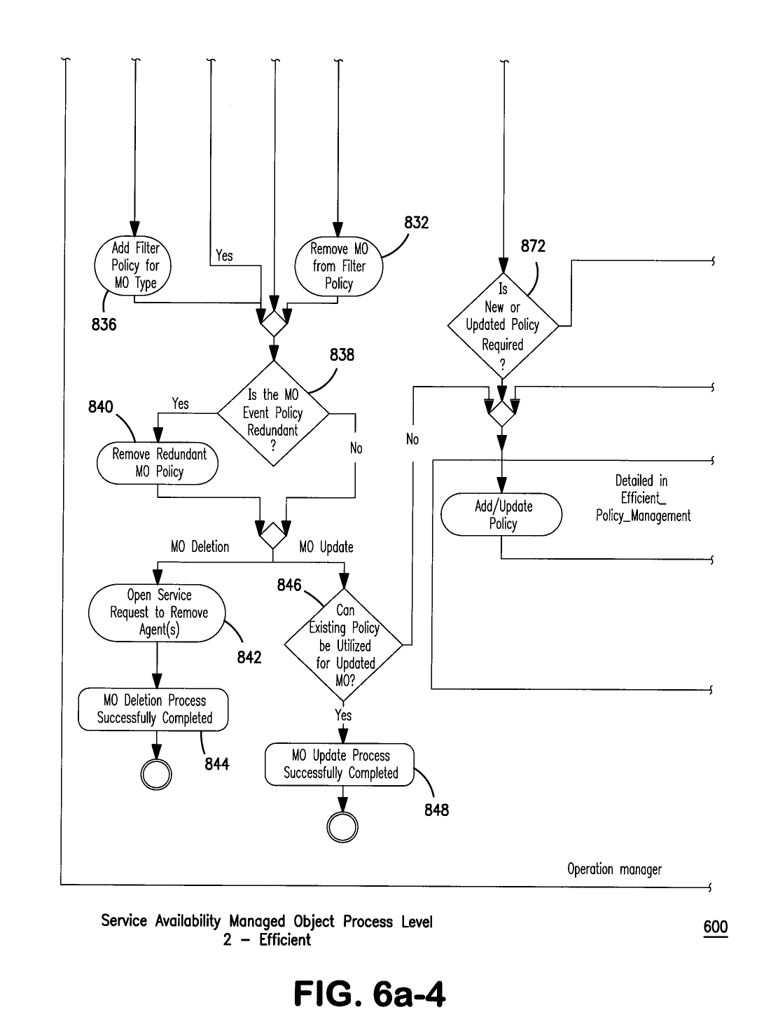

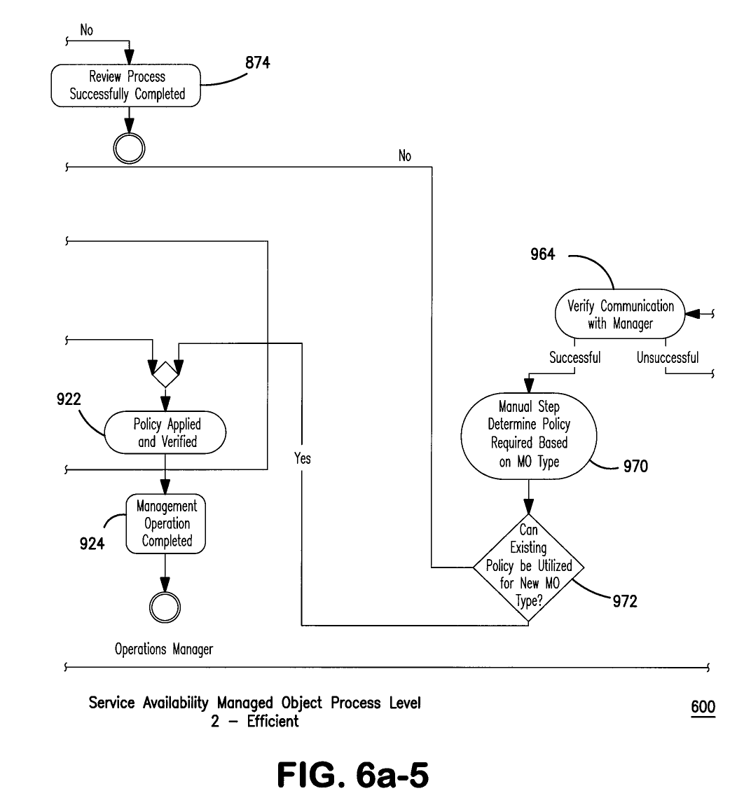

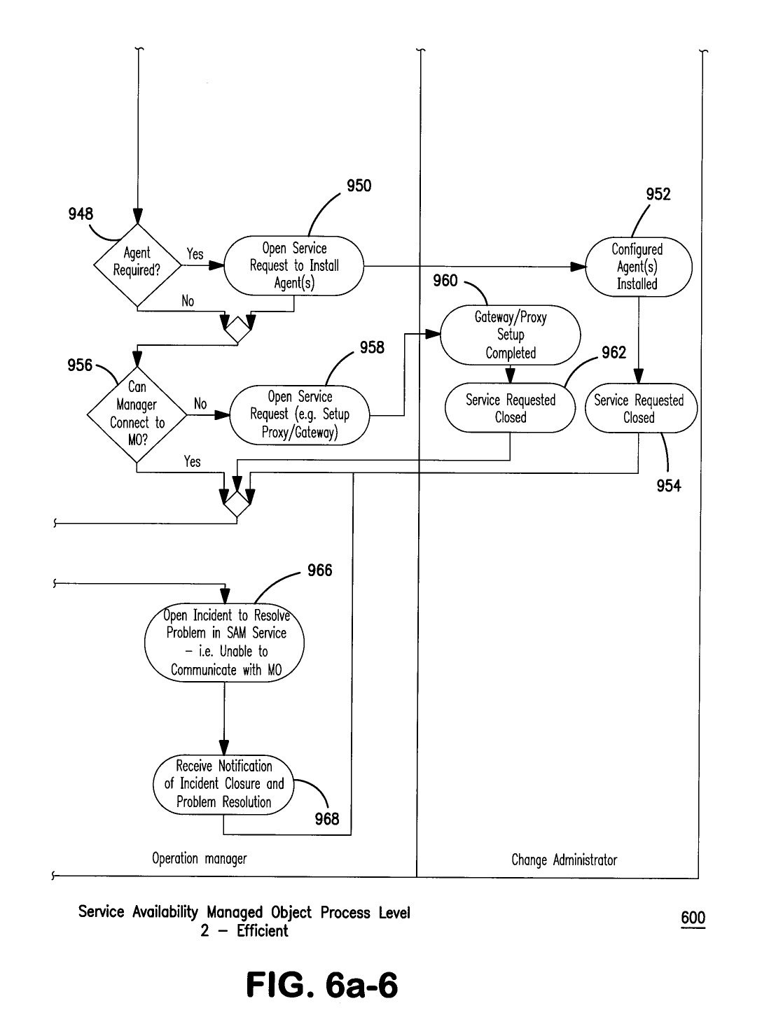

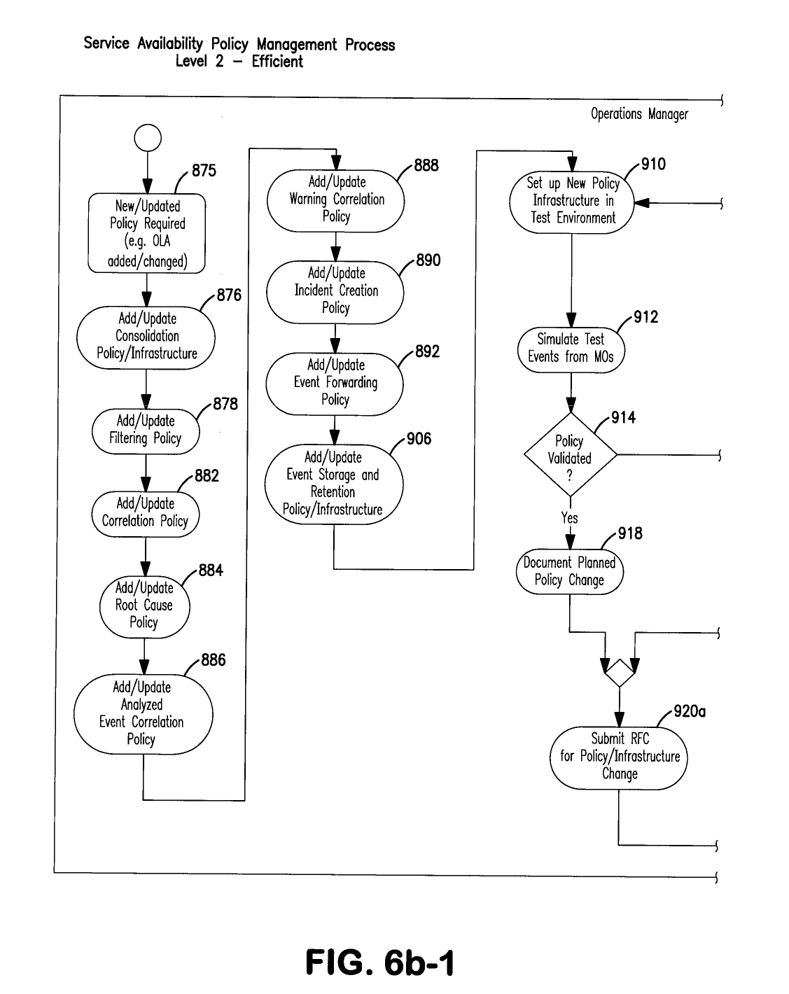

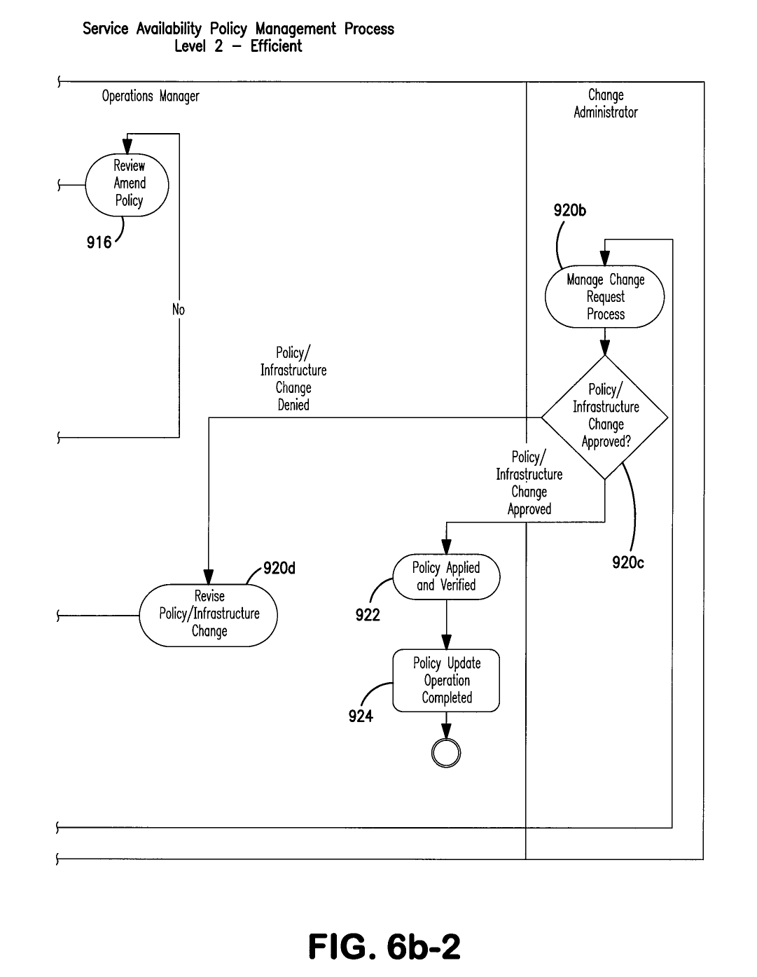

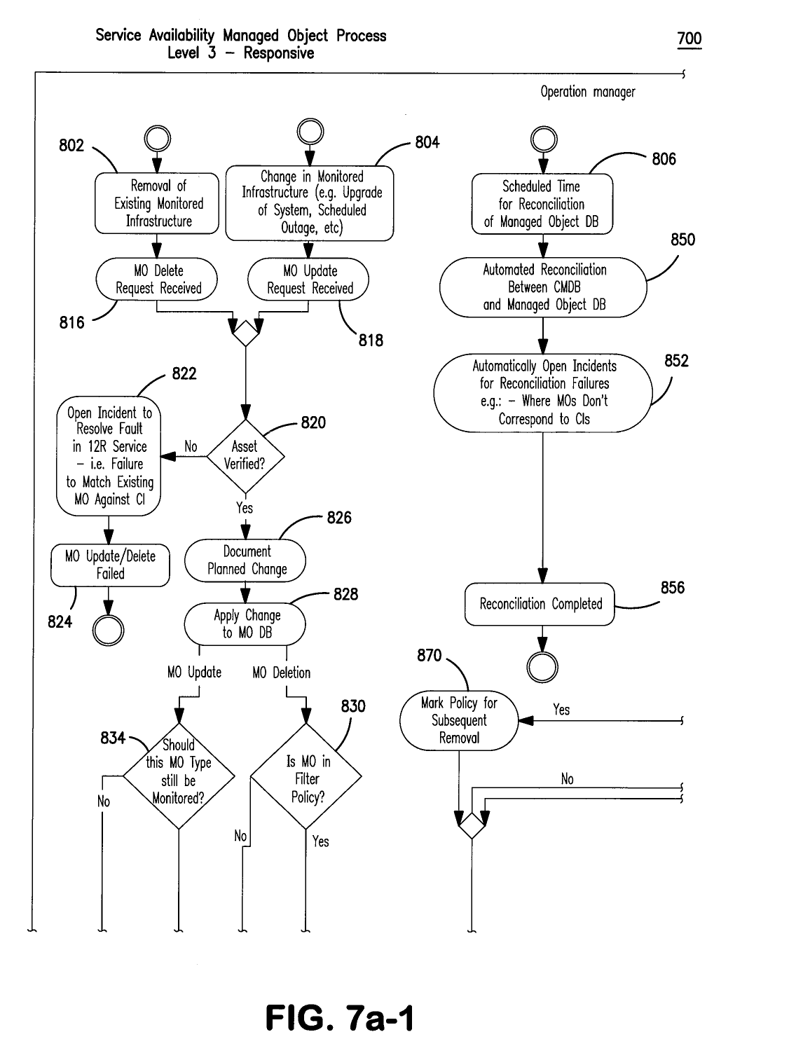

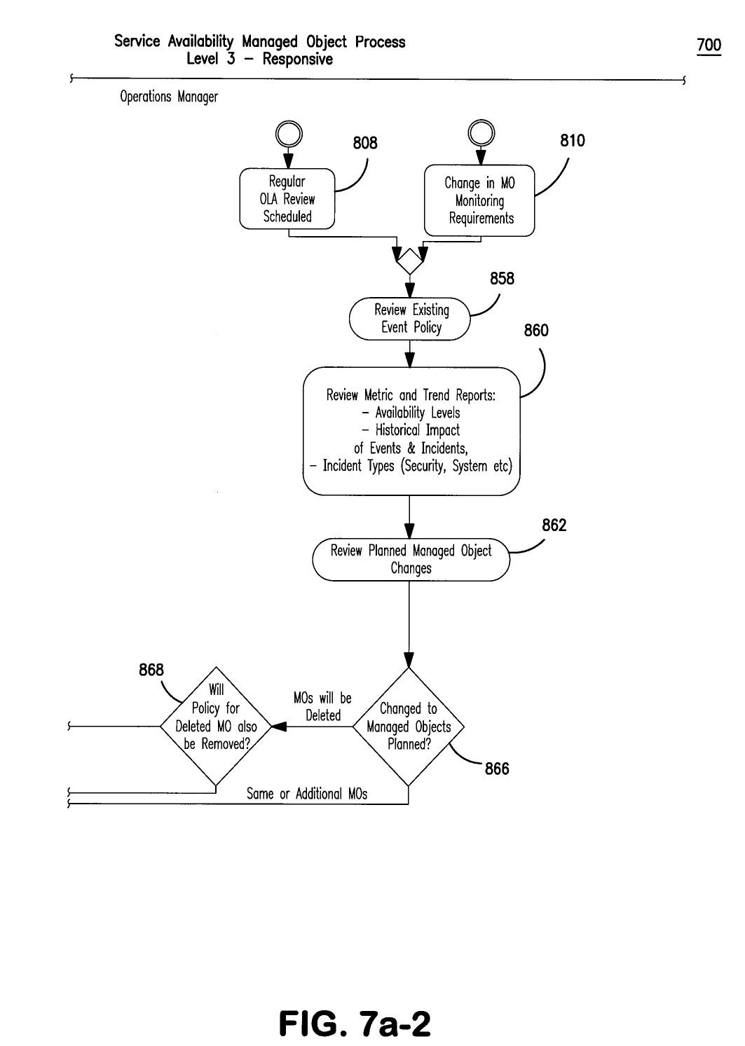

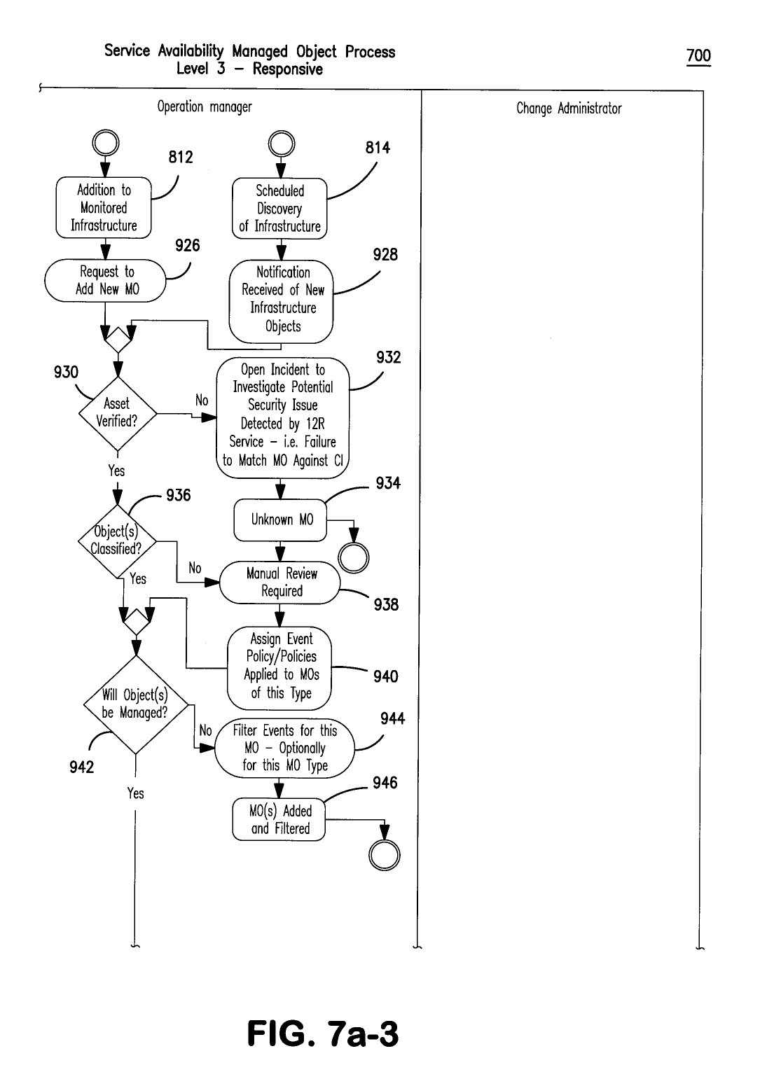

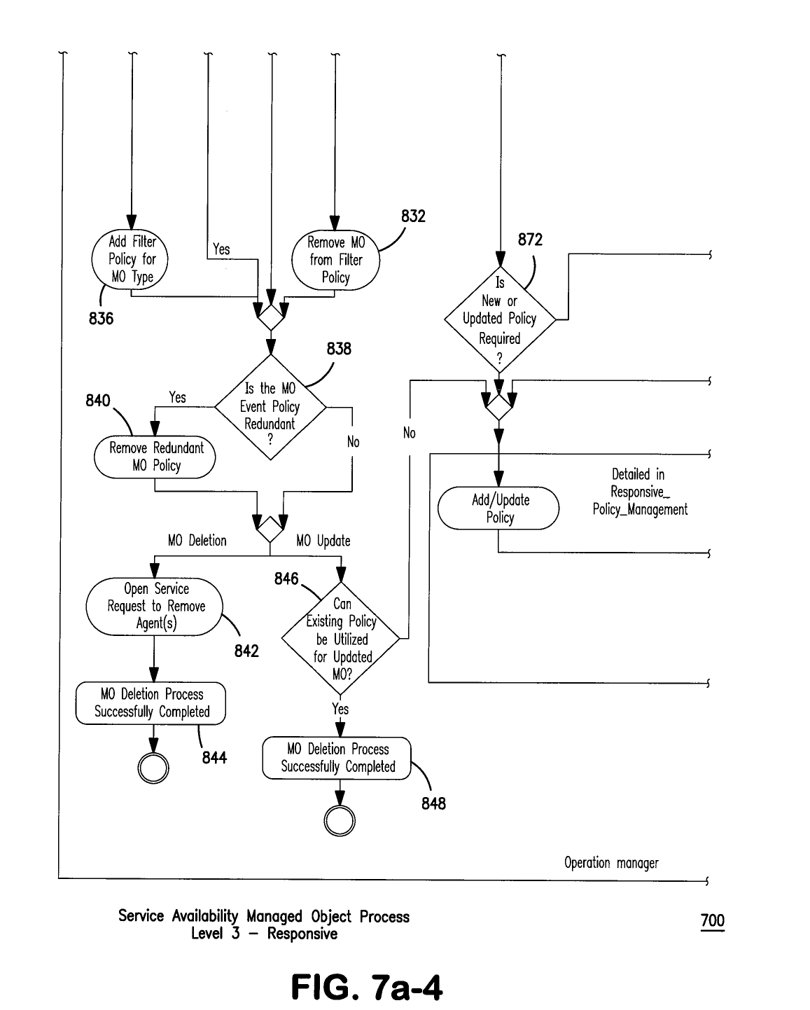

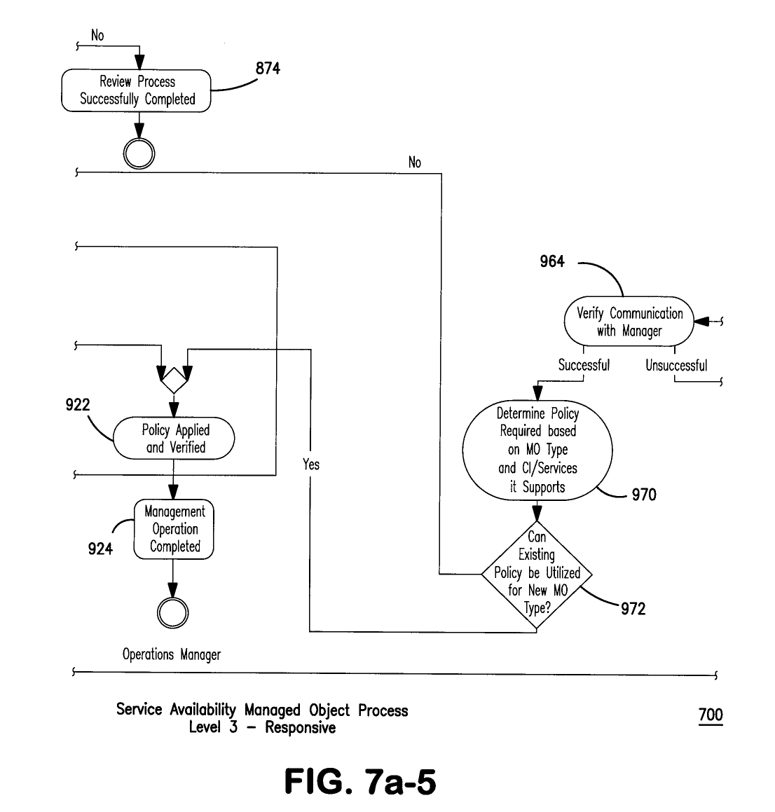

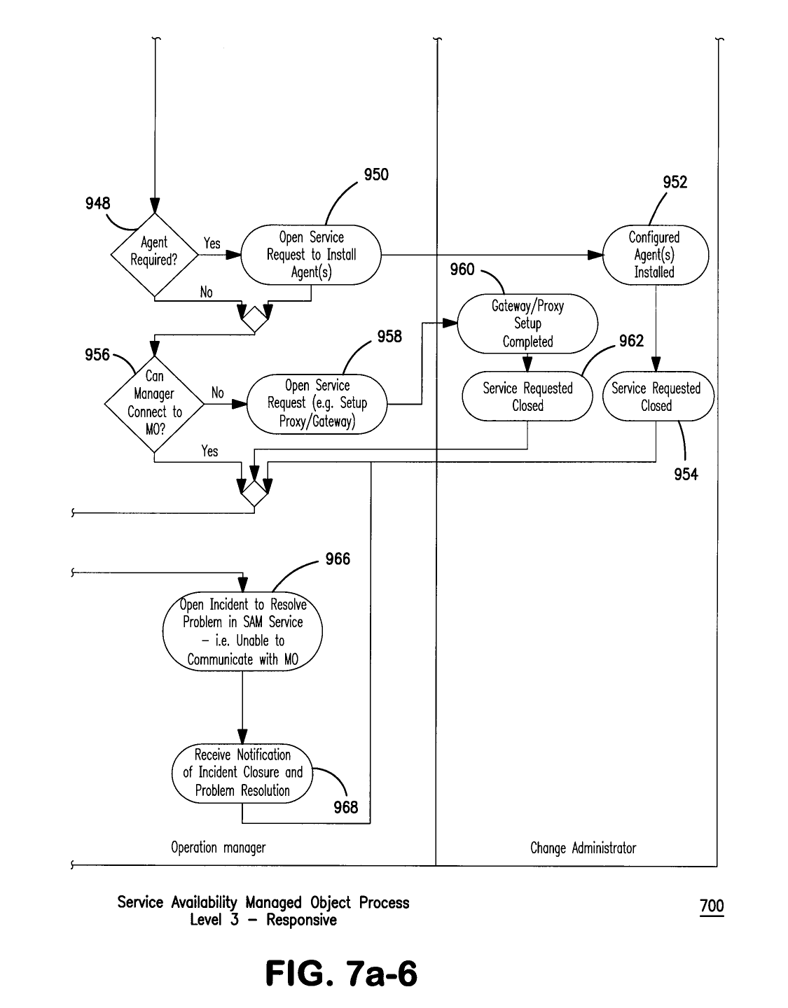

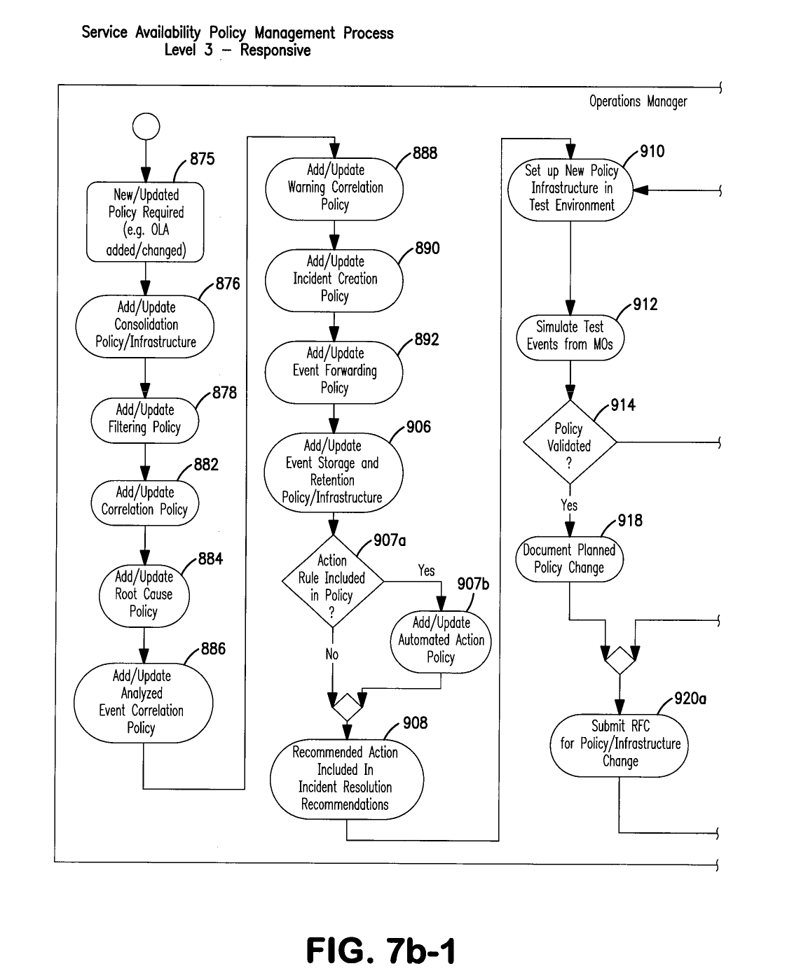

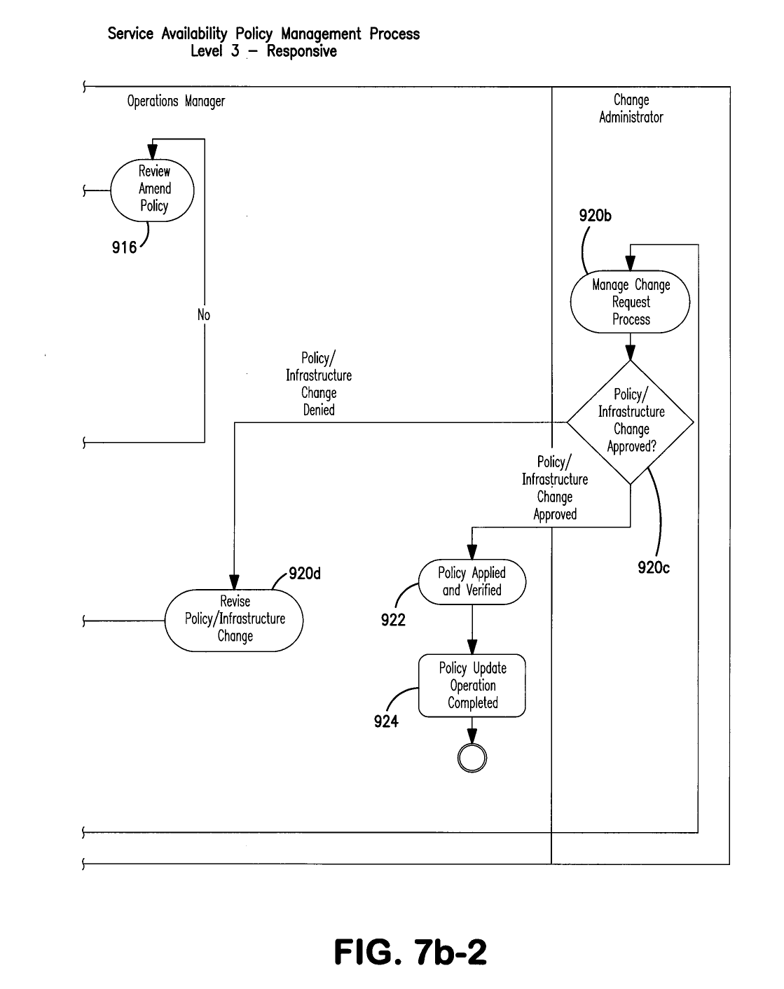

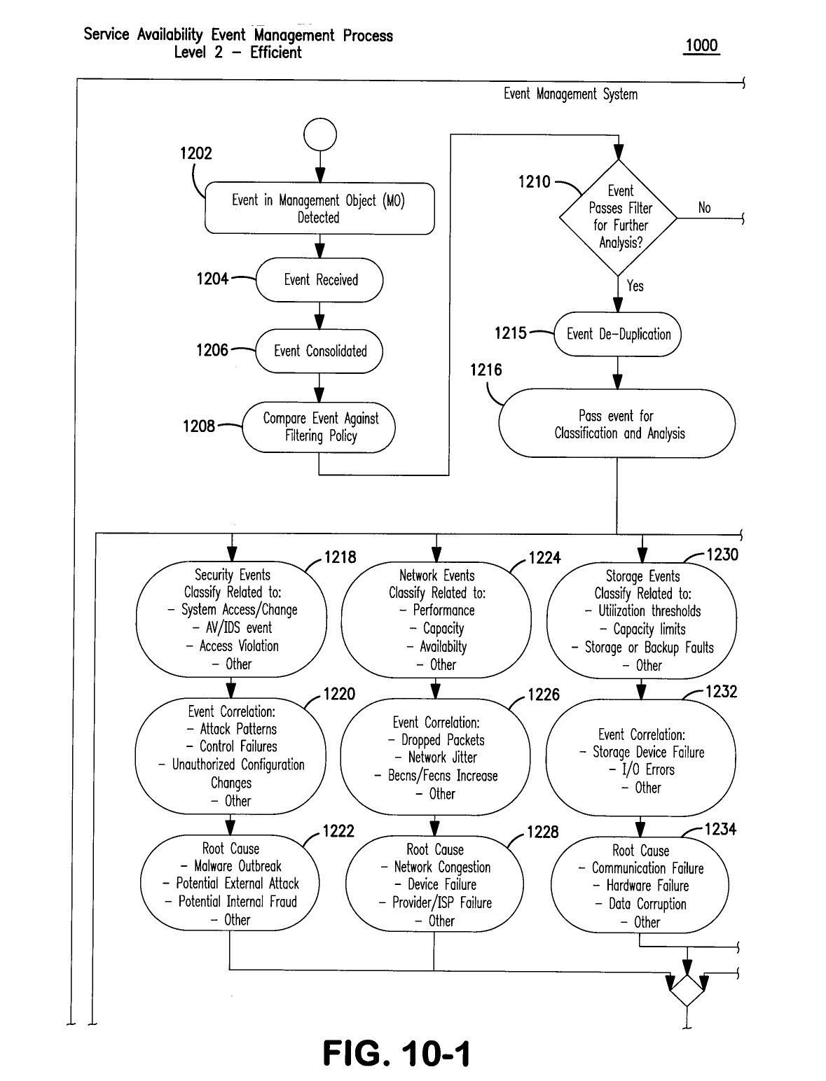

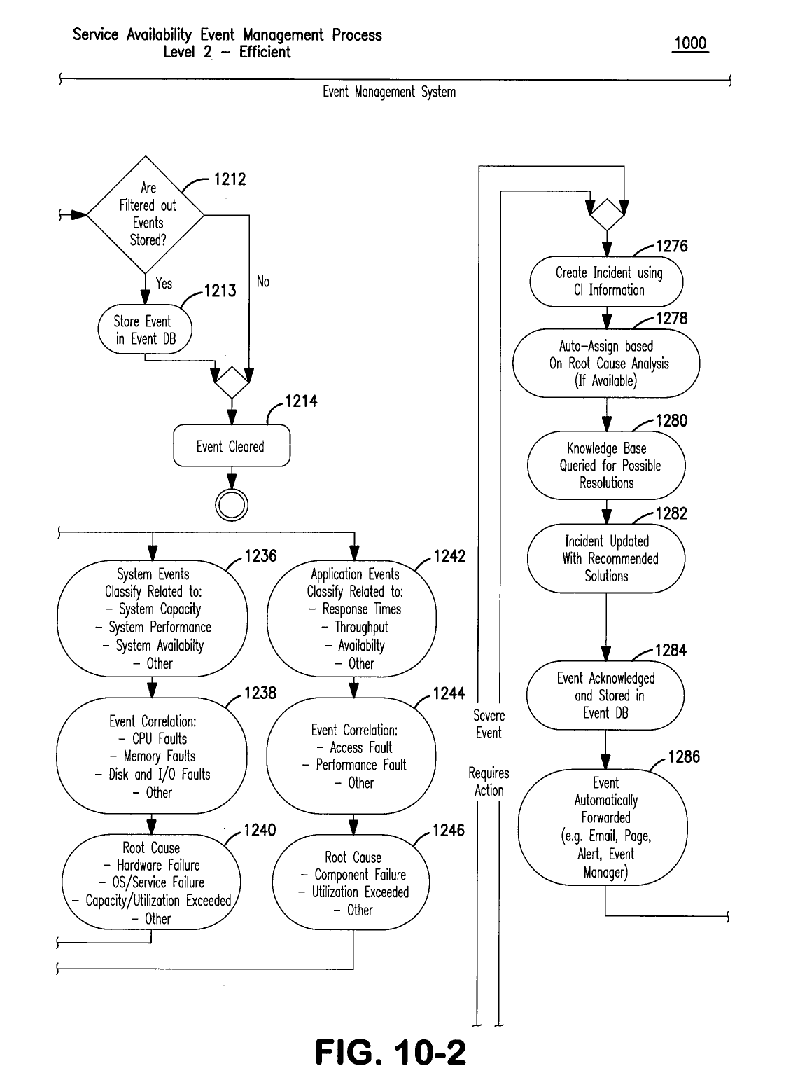

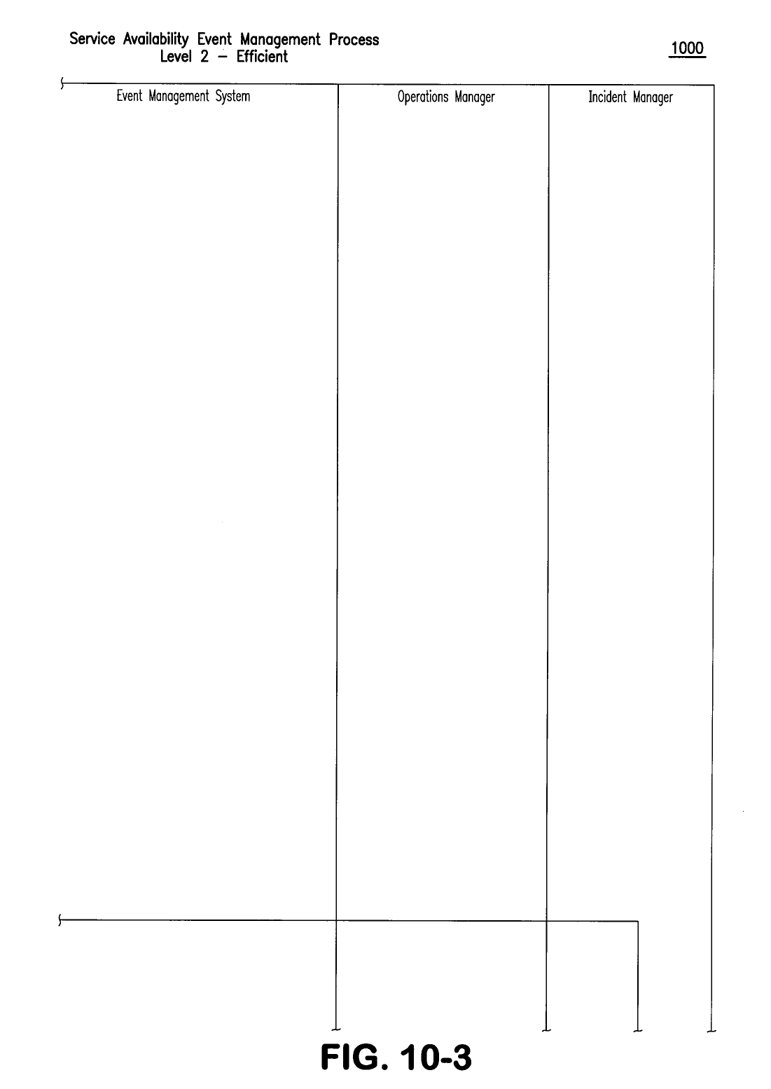

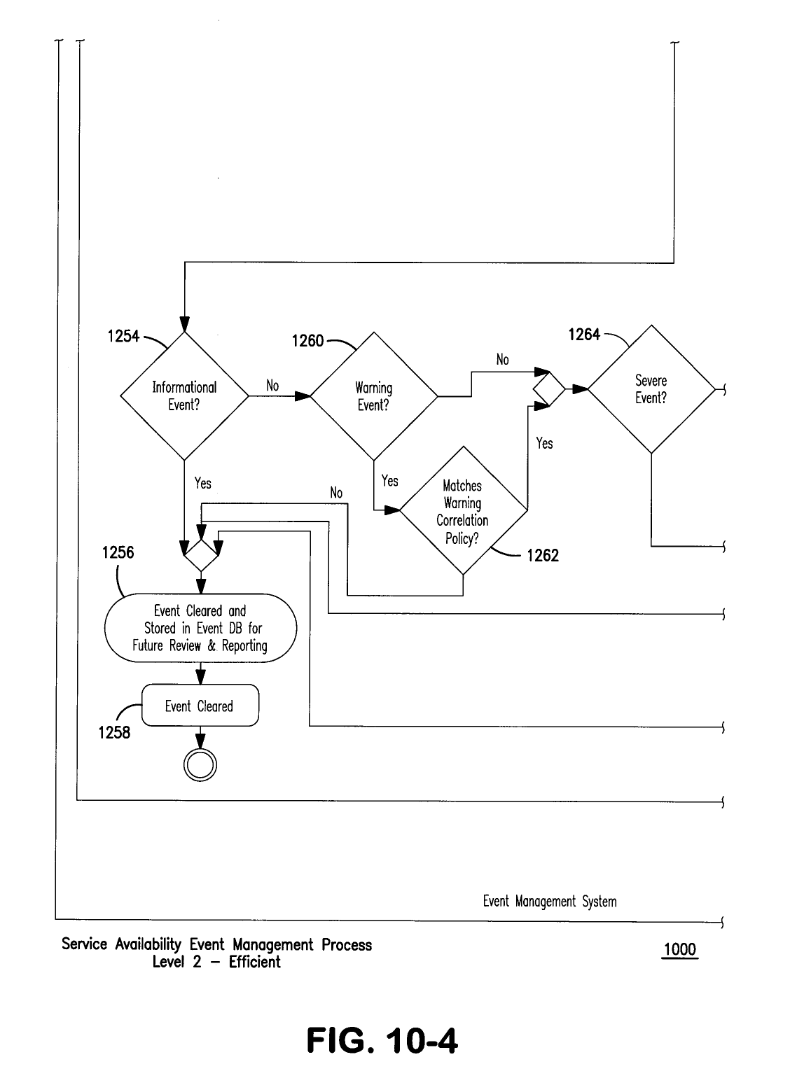

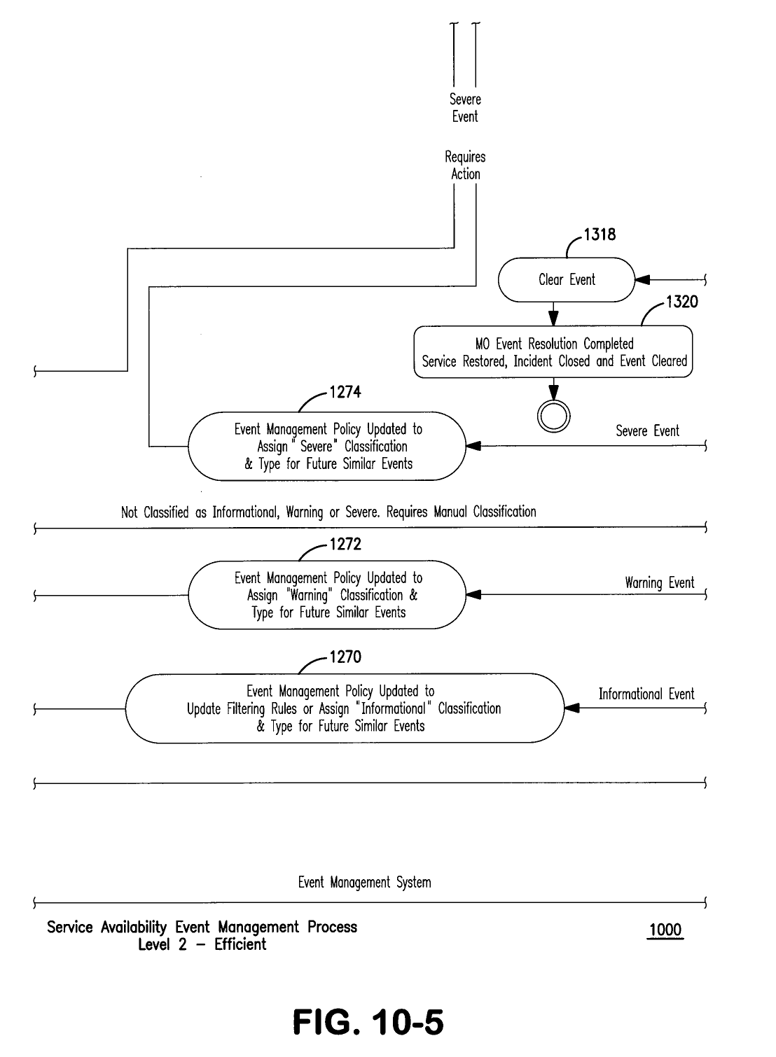

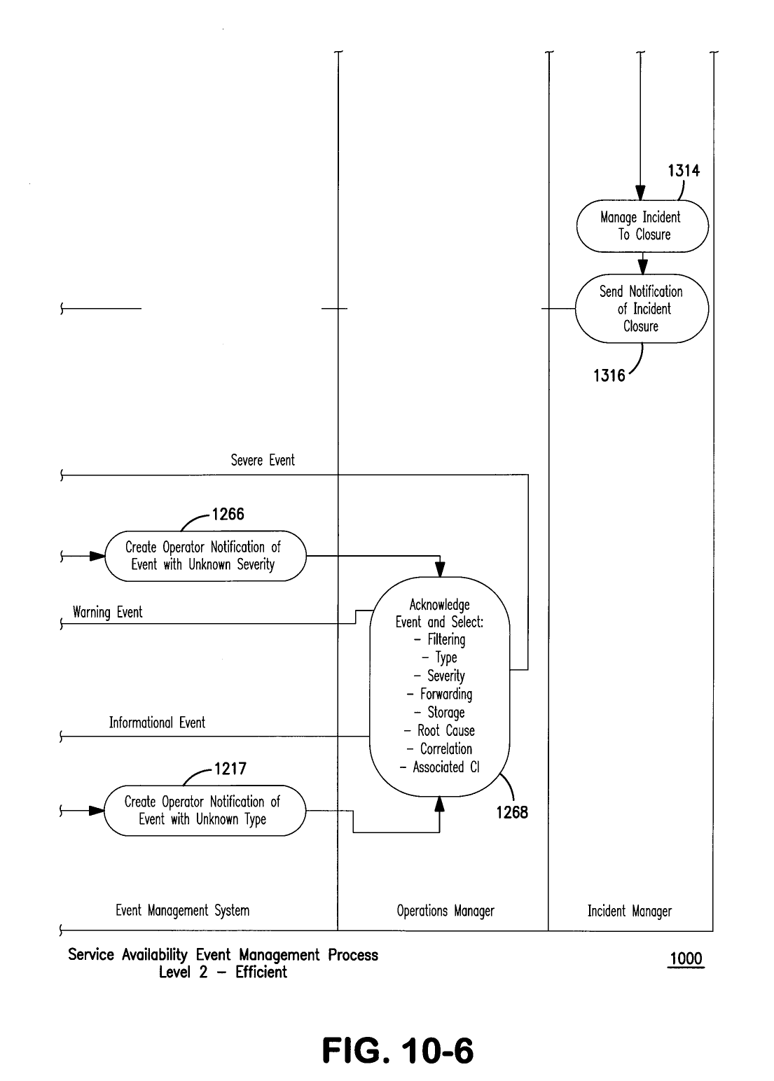

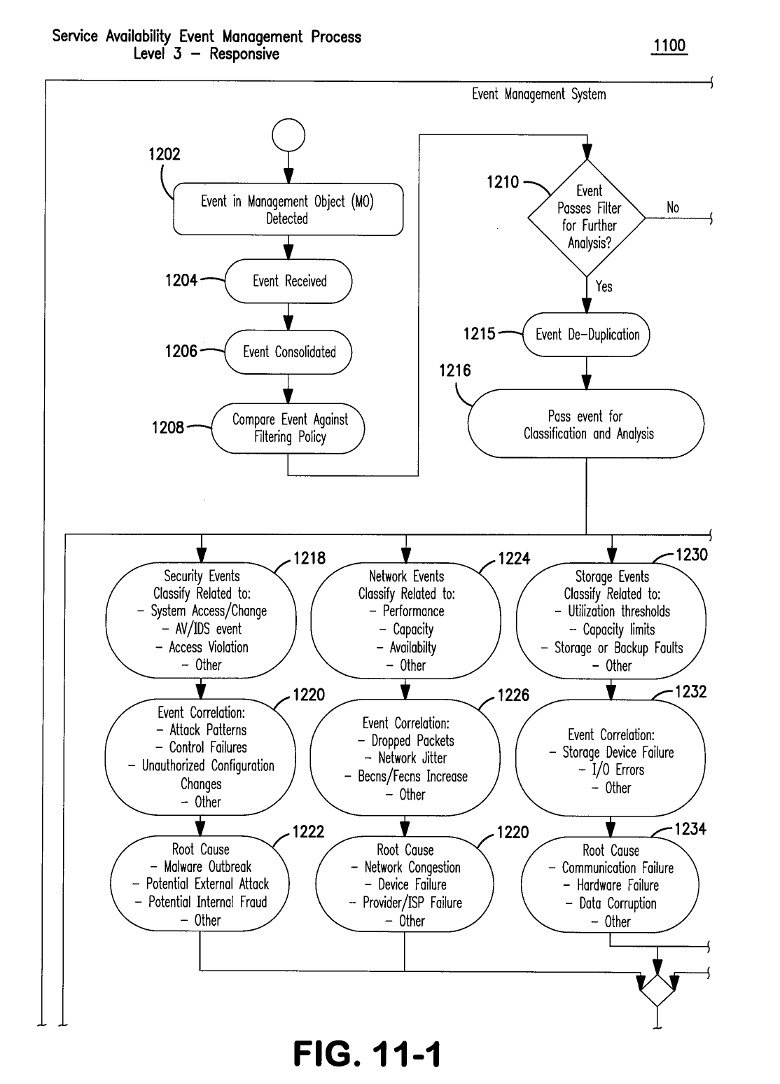

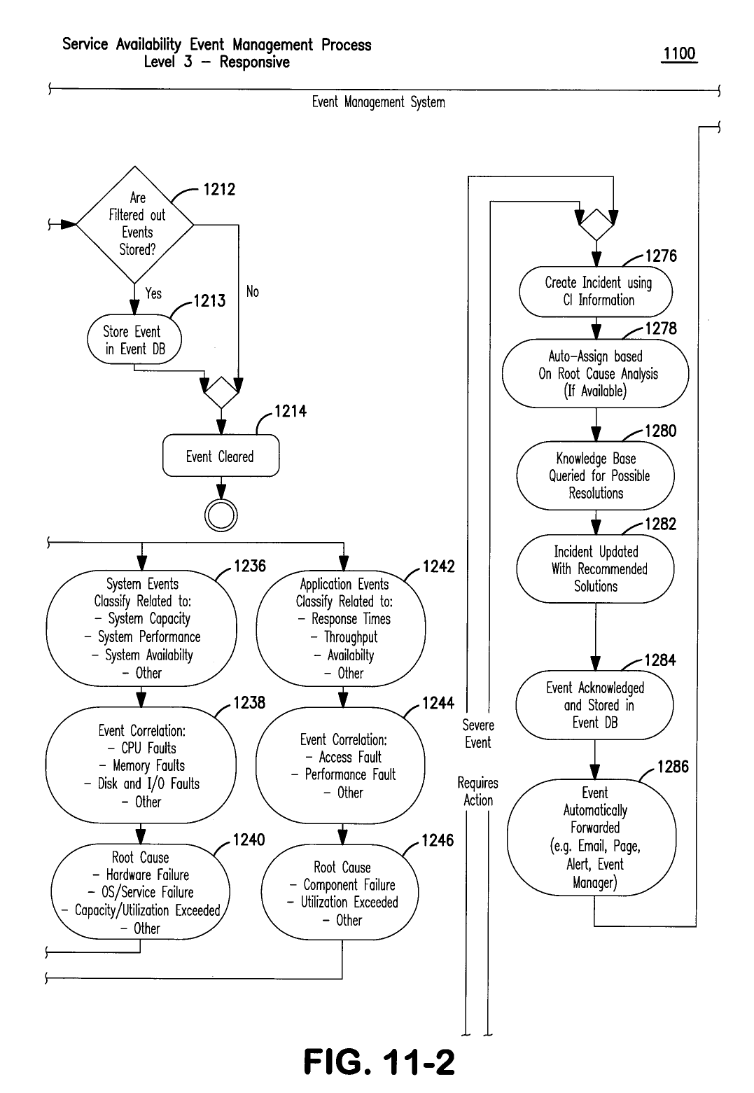

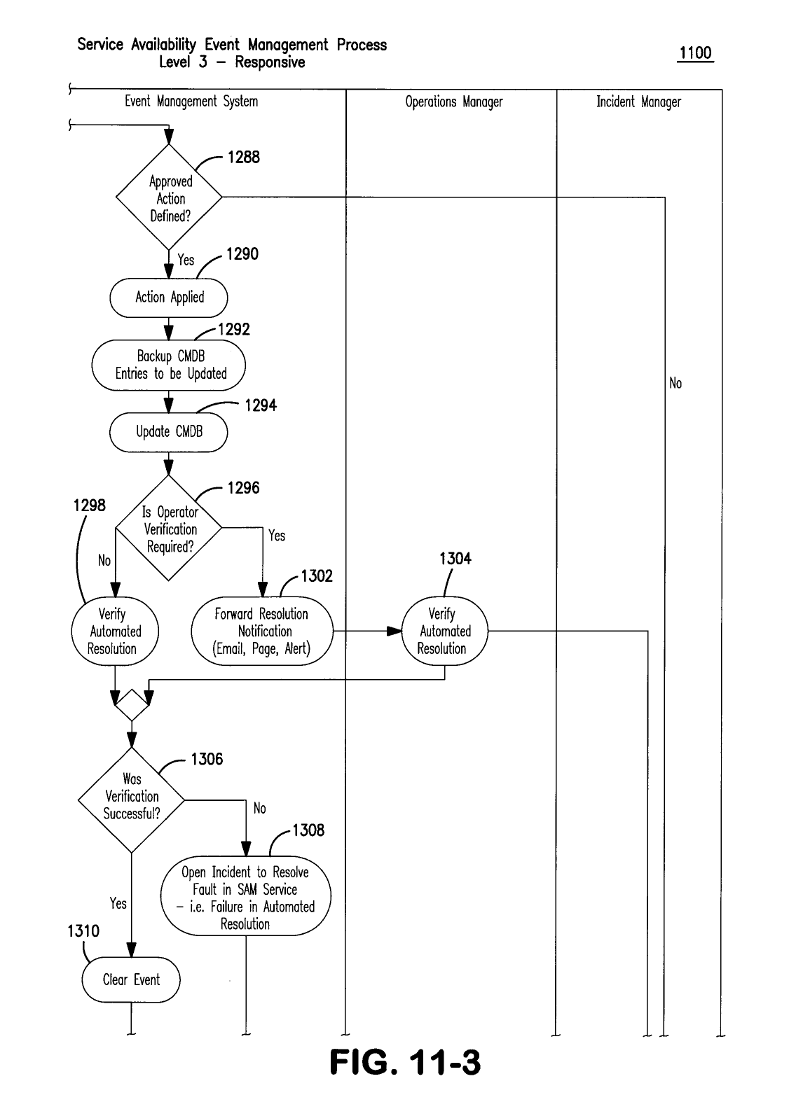

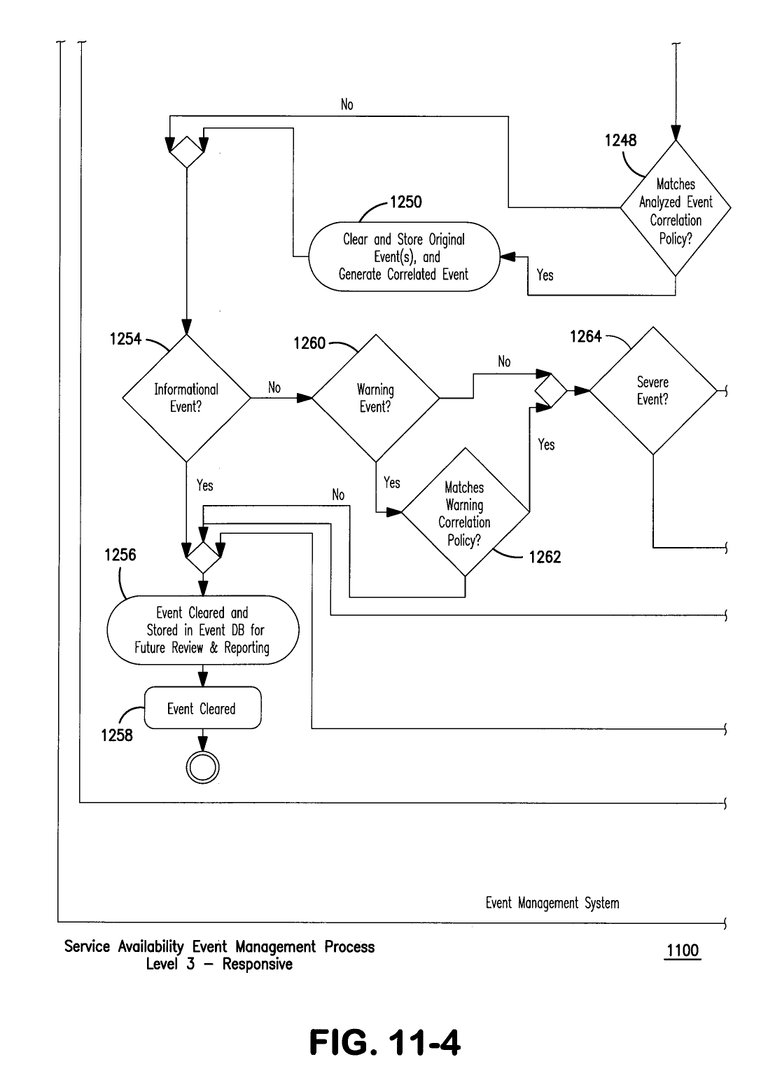

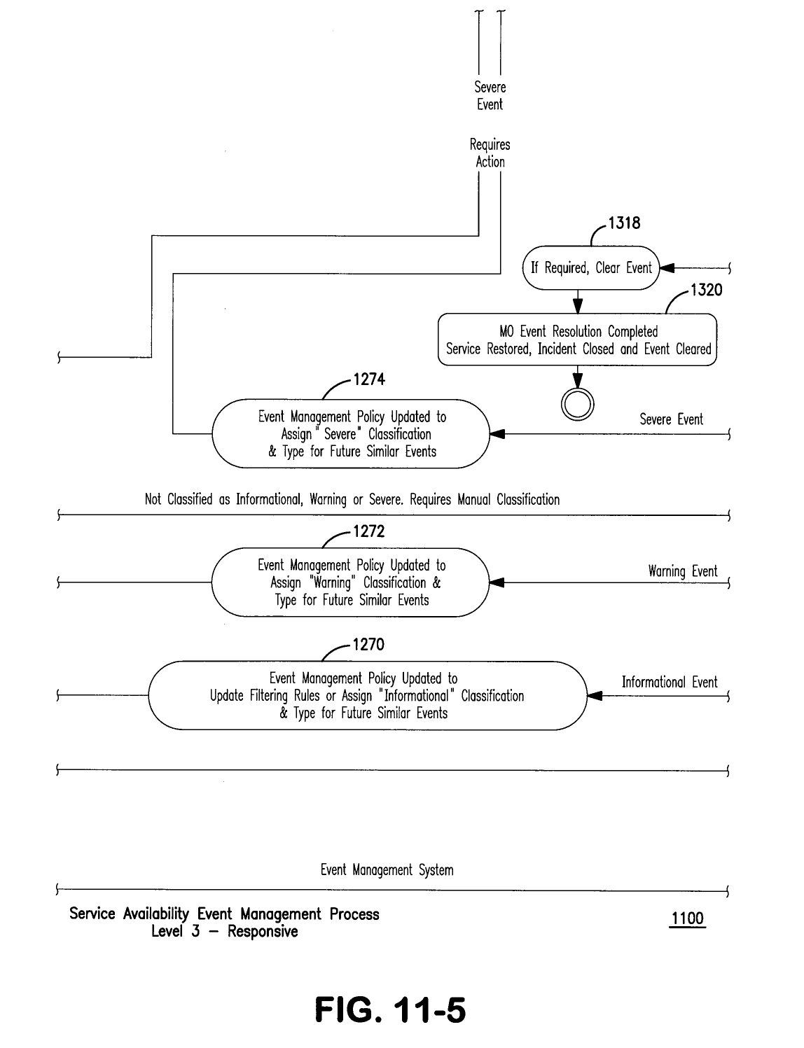

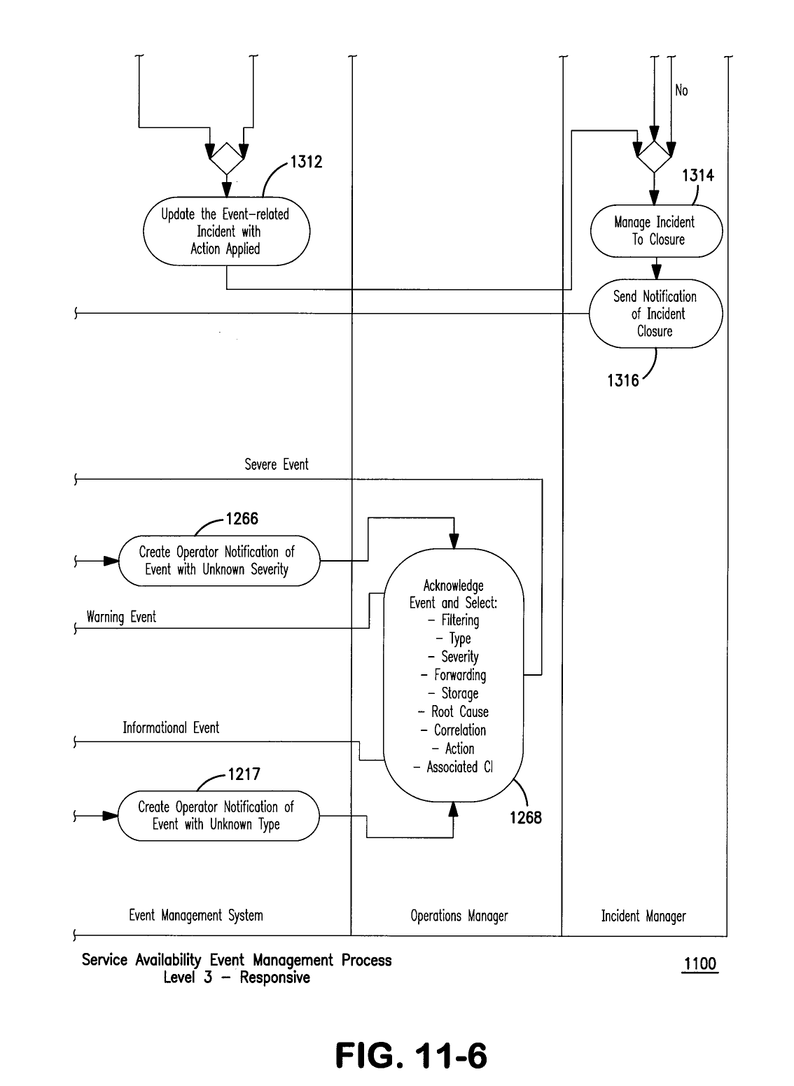

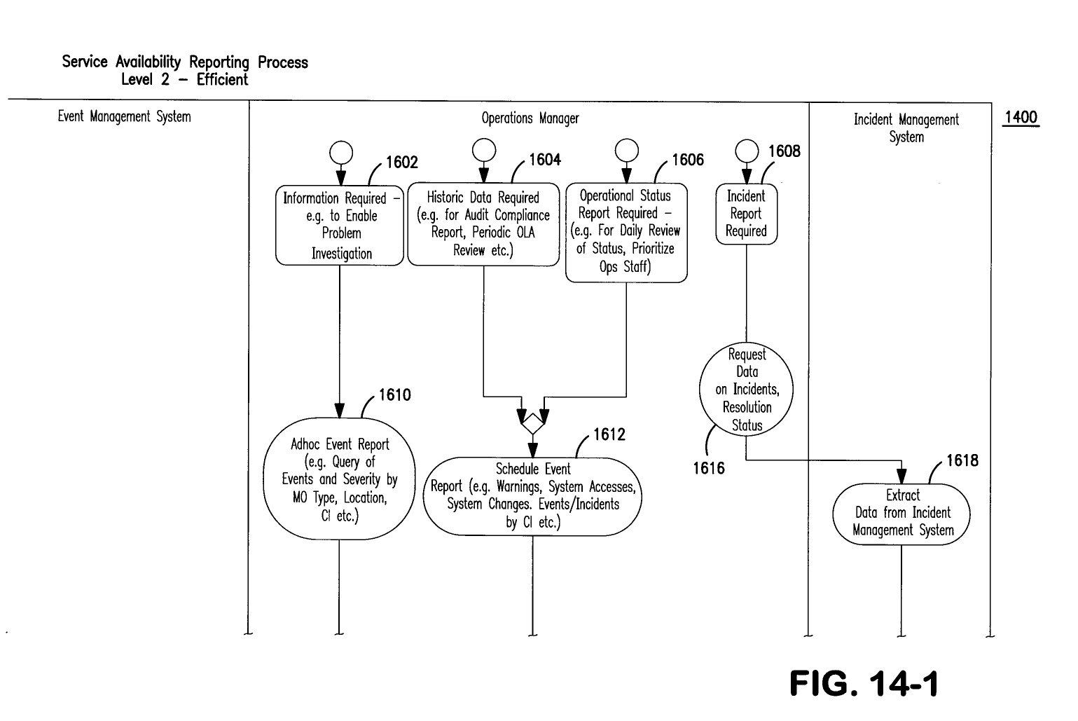

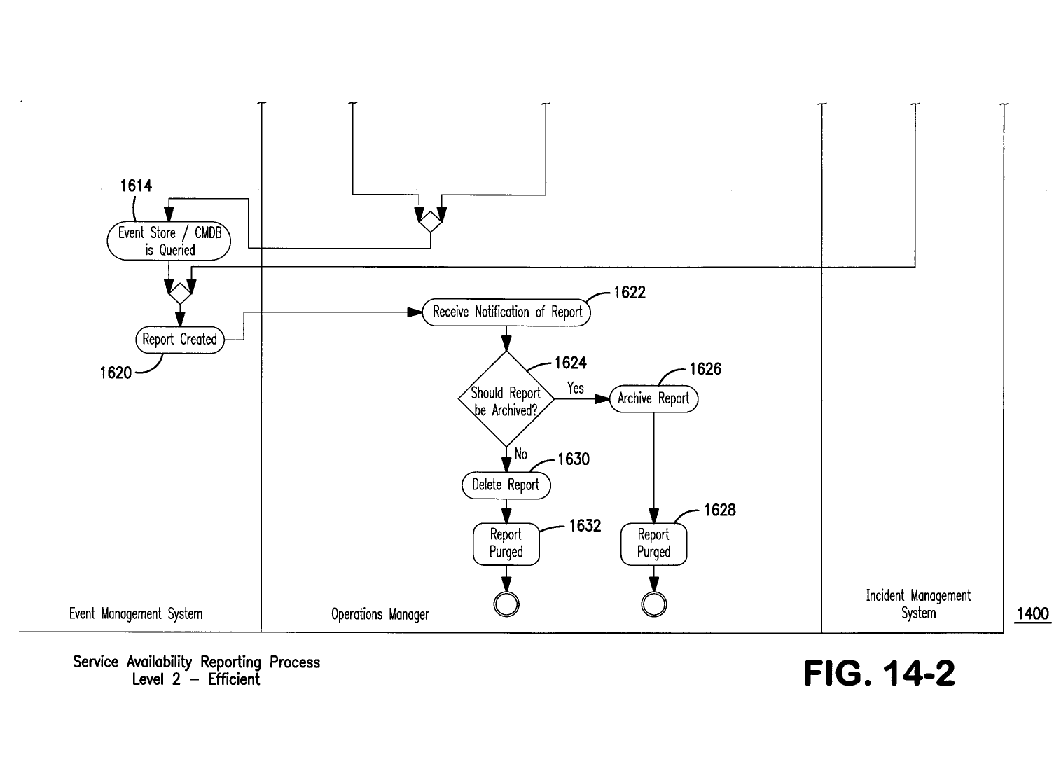

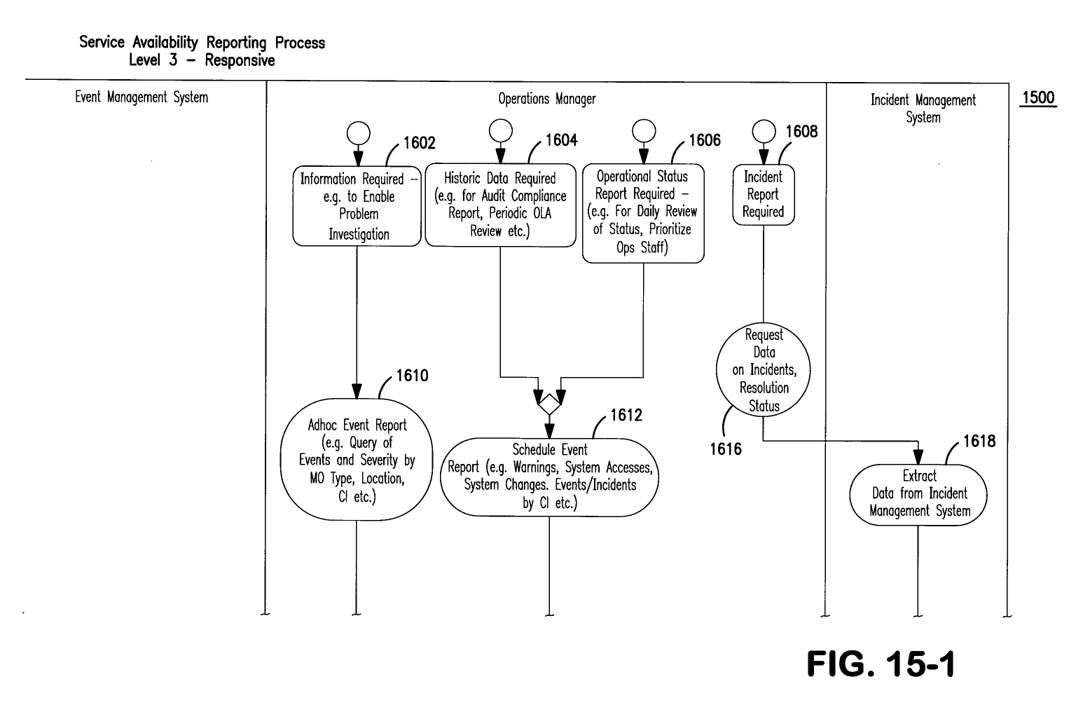

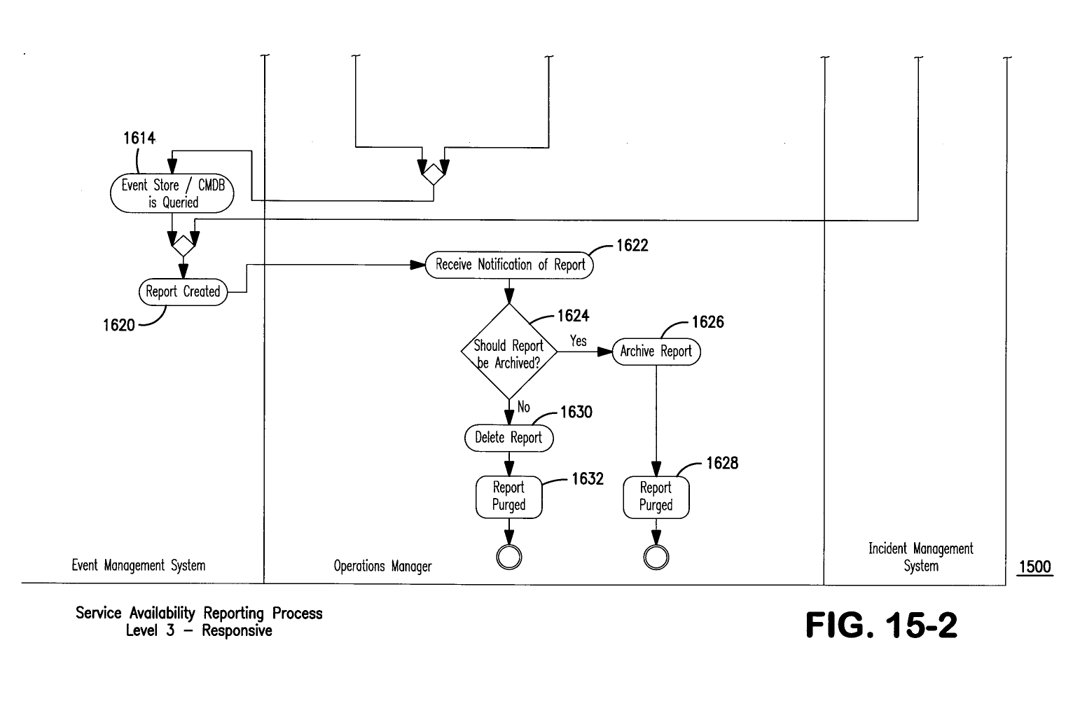

Embodiments of the present invention and their features and technical advantages may be understood by referring to FIGS. 1-16, like numerals being used for like corresponding parts in the various drawings.

Referring to FIG. 1, an arrangement 100 for resolving different types of events, according to an embodiment of the present invention, is depicted. Arrangement 100 may comprise a central system 108 and a plurality of lower level systems 102, e.g., a first lower level system 104 and a second lower level system 106, communicatively coupled to central system 108. For example, each of lower level systems 102 may be a security system, a network system, a storage system, a node or server system, an application system, or the like. Moreover, those of ordinary skill in the art readily will understand that lower level systems 102 may comprise any number of lower level systems. Central system 108 may comprise a filter and consolidation program 110, an event database 112, an event type determination program 114, an event policy manager 116, and an event policy database 118.

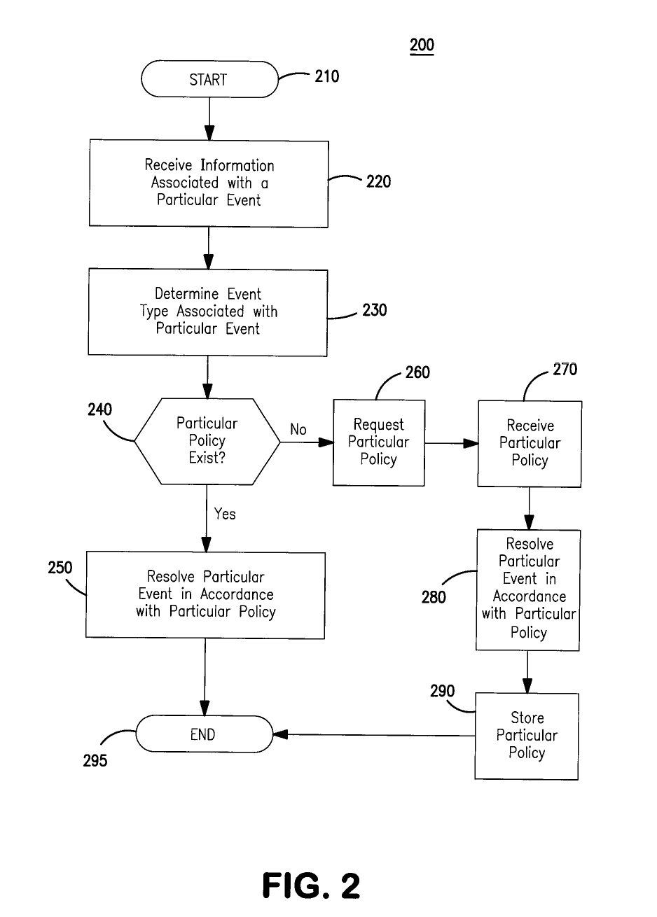

Referring to FIG. 2, a method 200 for resolving different types of events using arrangement 100, according to an embodiment of the present invention, is depicted. In step 210, method 200 begins, and in step 220, central system 108 receives information associated with a particular event from one of lower level systems 102. For example, the particular event may be a security event, a network event, a storage event, a node or server event, an application event, or the like. In one embodiment of the present invention, the particular event may have a status associated therewith, e.g., may have a critical status or a non-critical status, such as a warning status, an informational status, or the like, and filter and consolidation program 110 may consolidate repetitive events, filter and store information associated events that are non-critical events in event database 112, and transmit information associated with critical events to event type determination program 114. In step 230, event type determination program 114 determines the event type associated with the particular event. For example, event type determination program 114 may determine the event type based on which of lower level systems 102 transmitted the information associated with the particular event to central system 108, e., an event transmitted from a security system may be a security event type, an event transmitted from a network system may be a network event type, an event transmitted from a storage system may be a storage event type, an event transmitted from a node or server system may be a node or server event type, and an event transmitted from an application system may be an application event type.

In step 240 event policy manager 116 determines whether central system 108 comprises a particular policy associated with resolving the event type associated with the particular event, e.g., by accessing event policy database 118. If central system 108 comprises the particular policy, then in step 250 central system 108 resolves the particular event in accordance with the particular policy. For example, under the particular policy, central system 108 may forward information associated with the particular event to an operations manager system (not shown), such that an operation manager may review the information associated with the particular event, determine what service is affected by the particular event, create a help desk ticket associated with the particular event, and forward the information associated with the particular event (and other information if appropriate) to an appropriate incident manager in charge of resolving the particular event. Method 200 then may proceed to step 295 and the particular event may be cleared. If, however, in step 240 event policy manager 116 determines that central system 108 does not comprise the particular policy, then in step 260, central system 108 requests the particular policy, e.g., from the operations manager system. In step 270 central system 108 receives the particular policy, and step 280, central system 108 resolves the particular event in accordance with the particular policy. For example, under the particular policy, central system 108 may forward information associated with the particular event to the operations manager system, such that the operation manager may review the information associated with the particular event, determine what service is affected by the particular event, create a help desk ticket associated with the particular event, and forward the information associated with the particular event (and other information if appropriate) to an appropriate incident manager in charge of resolving the particular event. In step 290, central system 108 stores the particular policy in event policy database 118, such that the next time an event that is of the event type associated with the particular type of event occurs, central system 108 will comprise the particular policy, and will not have to request the particular policy. Method 200 then may proceed to step 295 and the particular event may be cleared.

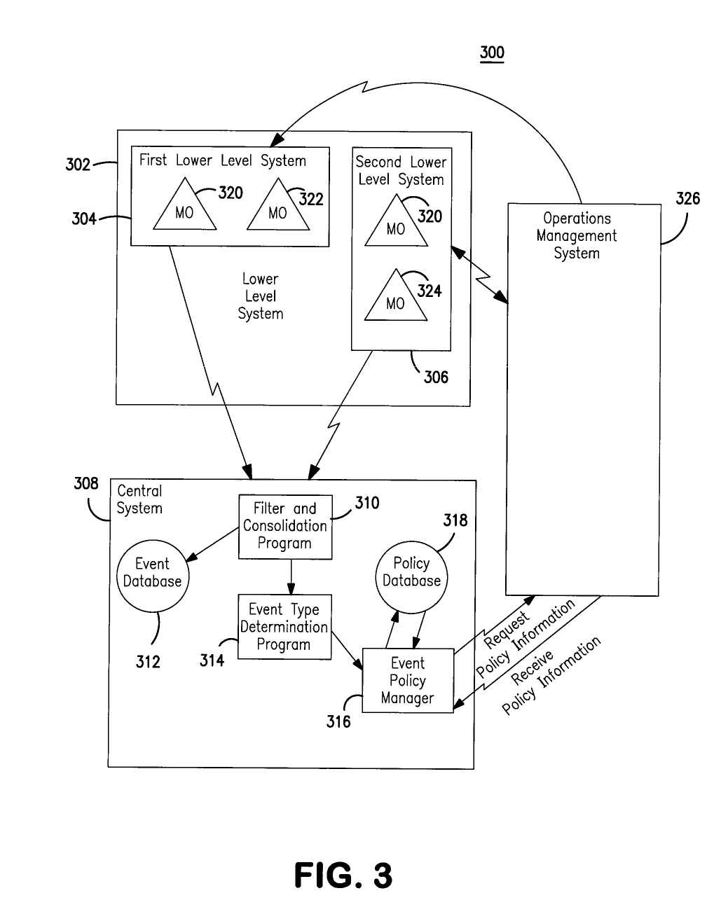

Referring to FIG. 3, an arrangement 300 for resolving different types of events, according to another embodiment of the present invention, is depicted. Arrangement 300 may comprise a central system 308, an operations manager system 326, and a plurality of lower level systems 302, e.g., a first lower level system 304 and a second lower level system 306, communicatively coupled to central system 308. For example, each of lower level systems 302 may be a security system, a network system, a storage system, a node or server system, an application system, or the like. In this embodiment, first lower level system 304 comprises a first object 320 and a second object 322, and second lower level system 306 comprises first object 320 and third object 324, e.g., in this embodiment, first object 320 is associated with both first lower level system 304 and second lower level system 306. Nevertheless, those of ordinary skill in the art readily will understand that lower level systems 302 may comprise any number of lower level systems, and each object may be associated with any number of lower level systems. Central system 308 may comprise a filter and consolidation program 310, an event database 312, an event type determination program 314, an event policy manager 316, and an event policy database 318.

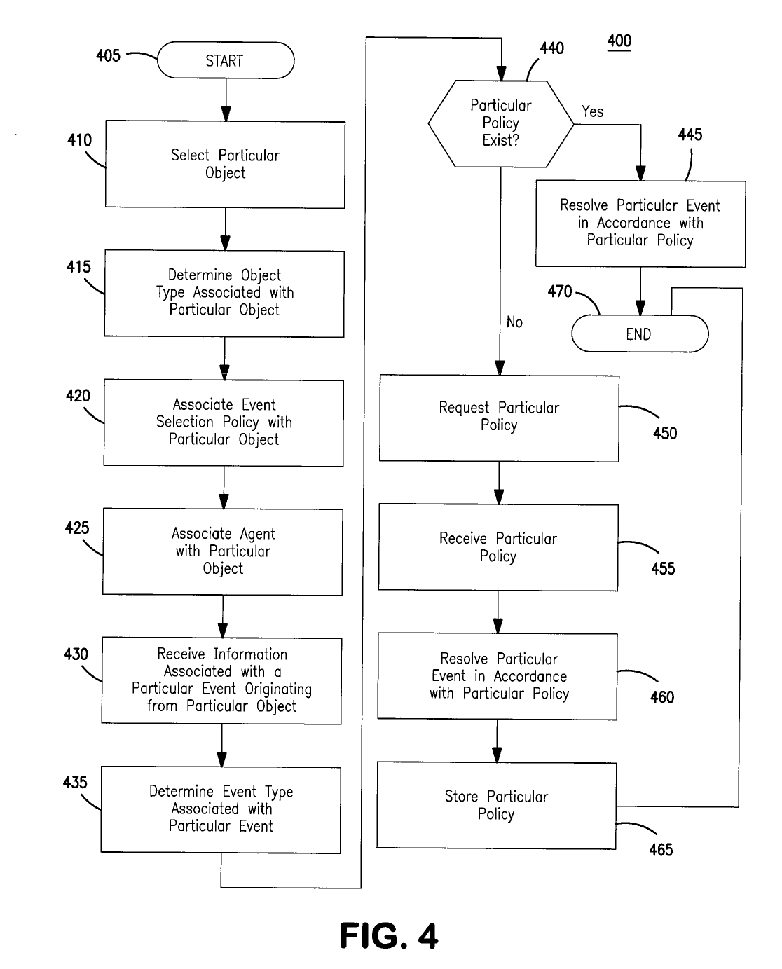

Referring to FIG. 4, a method 400 for managing objects and for resolving different types of events associated with the objects using arrangement 300, according to an embodiment of the present invention, is depicted. In step 405, method 400 begins, and in step 410, a particular object, e.g., one of objects 320, 322, and 324 is selected to be managed. For example, an operations manager may select the particular object via operations management system 326. In step 415, operations management system 326 determines an object type associated with the particular object, e.g., a server object type, an windows 2000 box object type, a storage unit object type, or the like. Those of ordinary skill in the art readily will understand that there may be any number of different object types. In step 420, an event selection policy is associated with the particular object based at least on the object type associated with the particular object. Specifically, the event selection policy indicates at least one event type that is associated with the particular object. In step 425, an agent, e.g., a software agent, may be associated with the particular object, and the agent being associated with one of the lower level systems. Those of ordinary skill in the art readily will understand that because the particular object may be associated with more than one of the lower level systems, it may be desirable to associate a plurality of agents with the particular object, with each agent being associated with a different one of the lower level systems. In step 430, central system 308 receives information associated with a particular event from one of lower level systems 302. For example, the particular event may be a security event, a network event, a storage event, a node or server event, an application event, or the like, and the particular event originates from the particular object. In one embodiment of the present invention, the particular event may have a status associated therewith, e.g., may have a critical status or a non-critical status, such as a warning status, an informational status, or the like, and filter and consolidation program 310 may consolidate repetitive events, filter and store information associated events that are non-critical events in event database 312, and transmit information associated with critical events to event type determination program 314. In step 435, event type determination program 314 determines the event type associated with the particular event. For example, event type determination program 314 may determine the event type based on which of lower level systems 302 transmitted the information associated with the particular event to central system 308, e.g., an event transmitted from a security system may be a security event type, an event transmitted from a network system may be a network event type, an event transmitted from a storage system may be a storage event type, an event transmitted from a node or server system may be a node or server event type, and an event transmitted from an application system may be an application event type.

In step 440 event policy manager 316 determines whether central system 308 comprises a particular policy associated with resolving the event type associated with the particular event, e.g., by accessing event policy database 318. If central system 308 comprises the particular policy, then in step 445 central system 308 resolves the particular event in accordance with the particular policy. For example, under the particular policy, central system 308 may forward information associated with the particular event to operations manager system 326, such that an operation manager may review the information associated with the particular event, determine what service is affected by the particular event, create a help desk ticket associated with the particular event, and forward the information associated with the particular event (and other information if appropriate) to an appropriate incident manager in charge of resolving the particular event. Method 400 then may proceed to step 470 and the particular event may be cleared. If, however, in step 440 event policy manager 416 determines that central system 408 does not comprise the particular policy, then in step 450, central system 308 requests the particular policy, e.g., from operations manager system 326. In step 455 central system 408 receives the particular policy, and step 460, central system 308 resolves the particular event in accordance with the particular policy. For example, under the particular policy, central system 408 may forward information associated with the particular event to operations manager system 326, such that the operation manager may review the information associated with the particular event, determine what service is affected by the particular event, create a help desk ticket associated with the particular event, and forward the information associated with the particular event (and other information if appropriate) to an appropriate incident manager in charge of resolving the particular event. In step 463, central system 308 stores the particular policy in event policy database 318, such that the next time an event that is of the event type associated with the particular type of event occurs, central system 308 will comprise the particular policy, and will not have to request the particular policy. Method 400 then may proceed to step 470 and the particular event may be cleared.

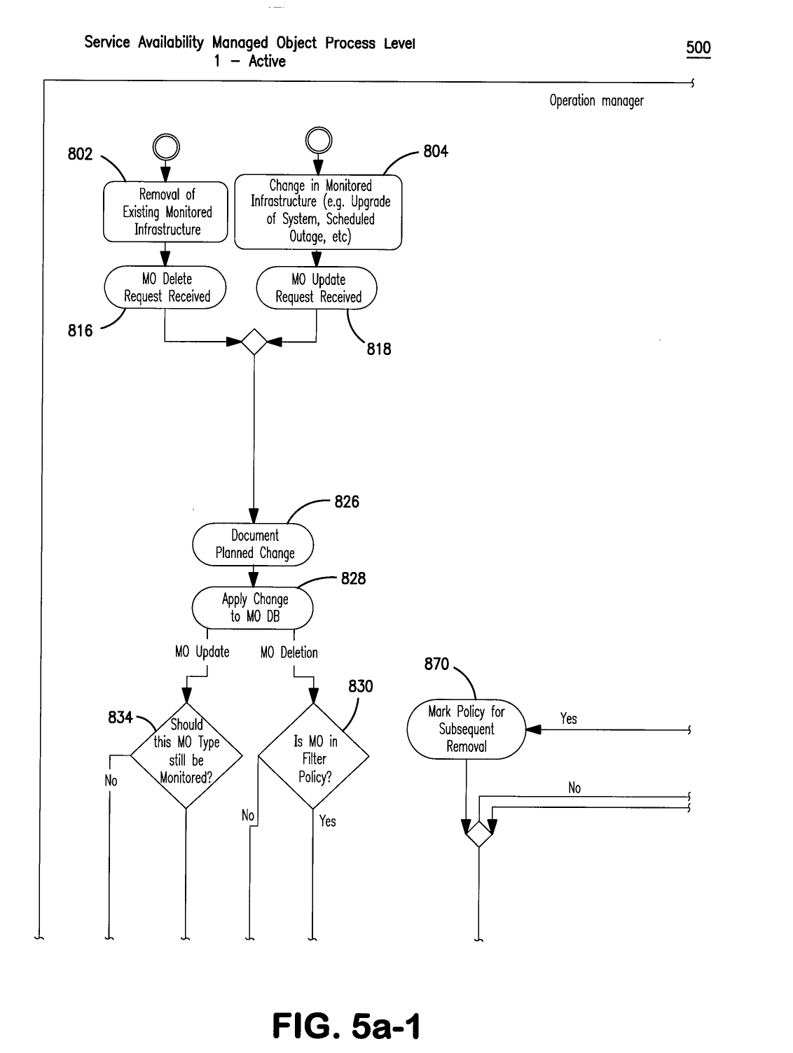

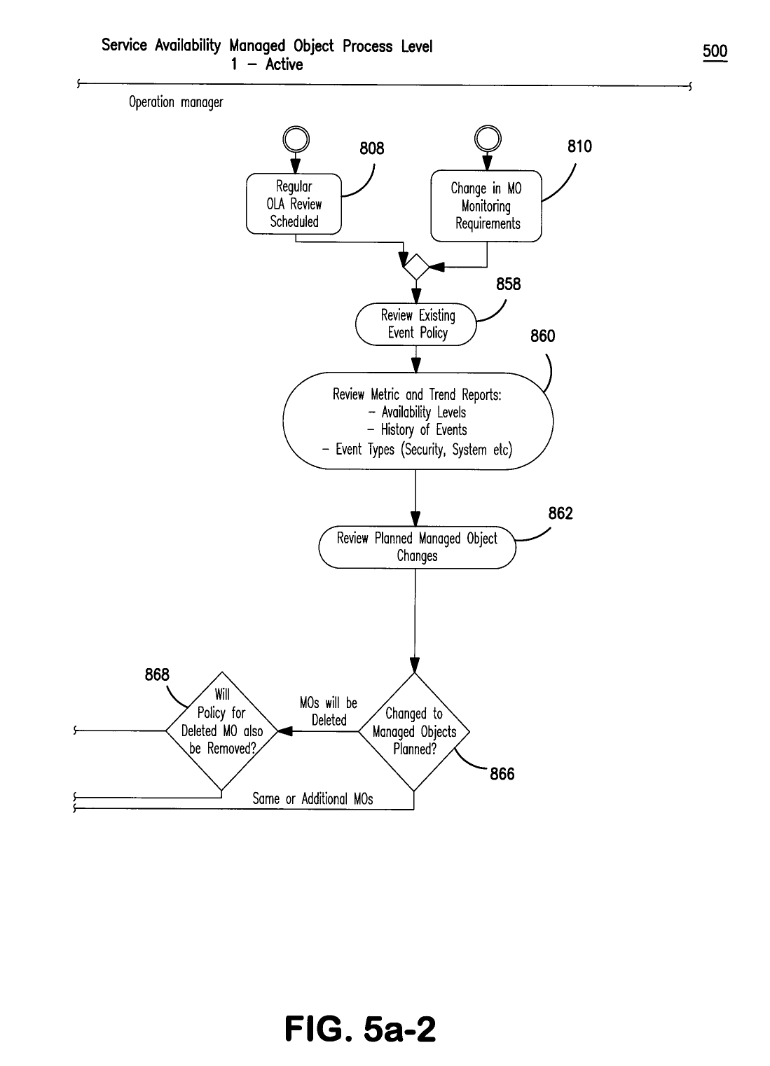

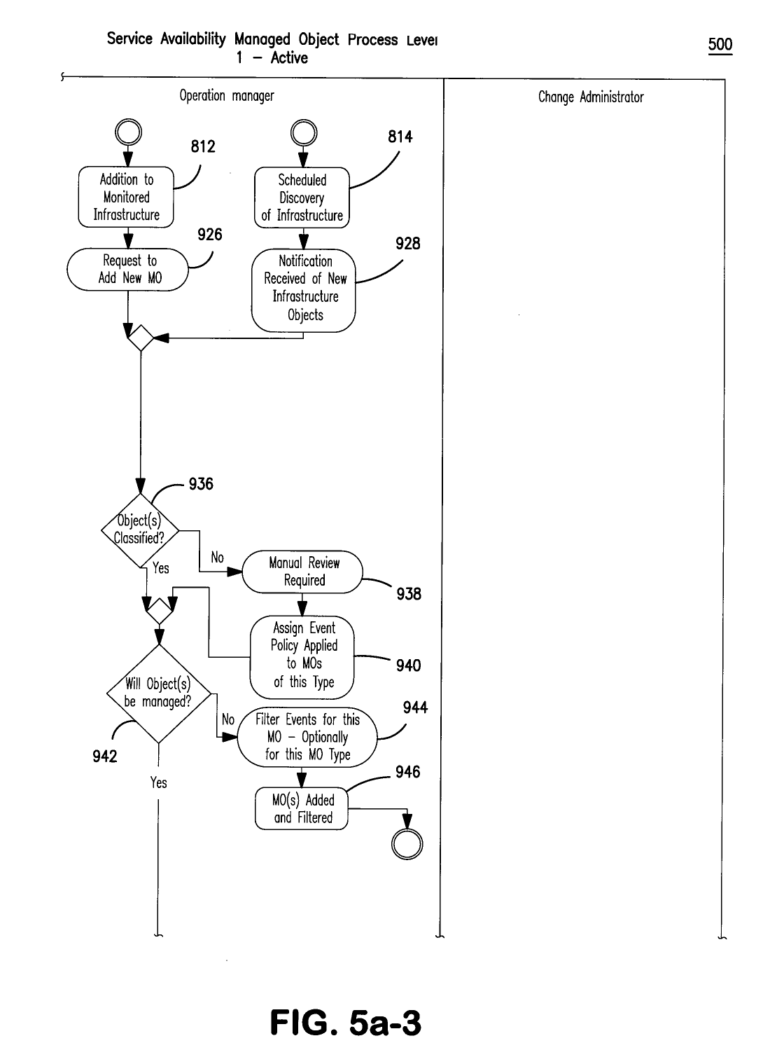

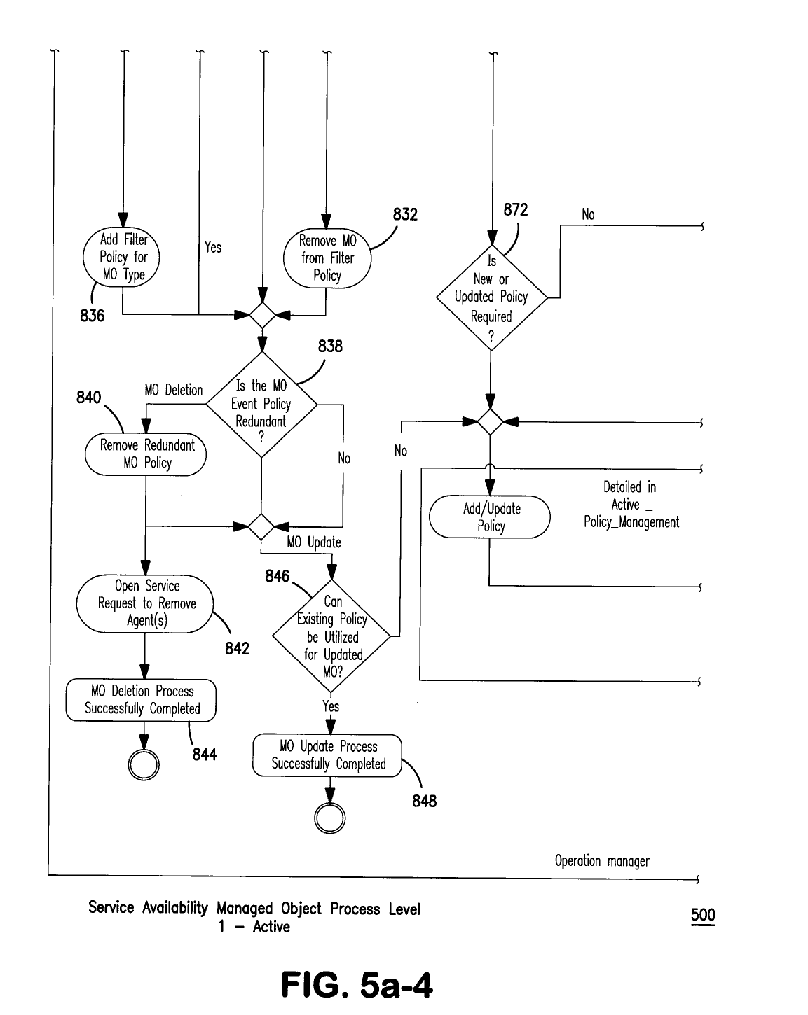

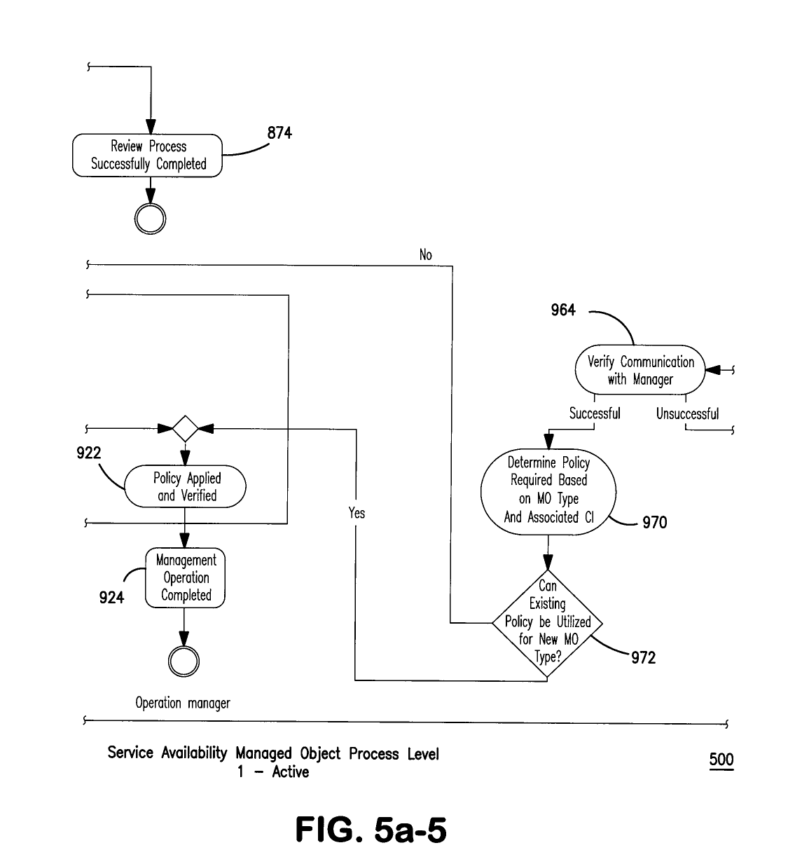

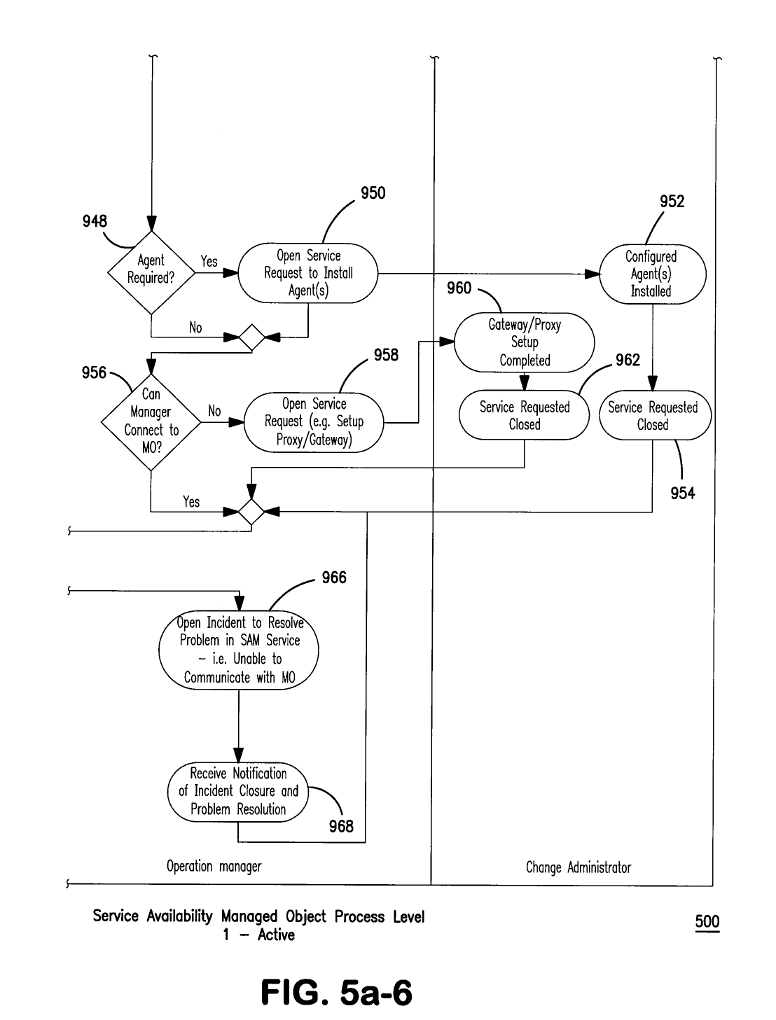

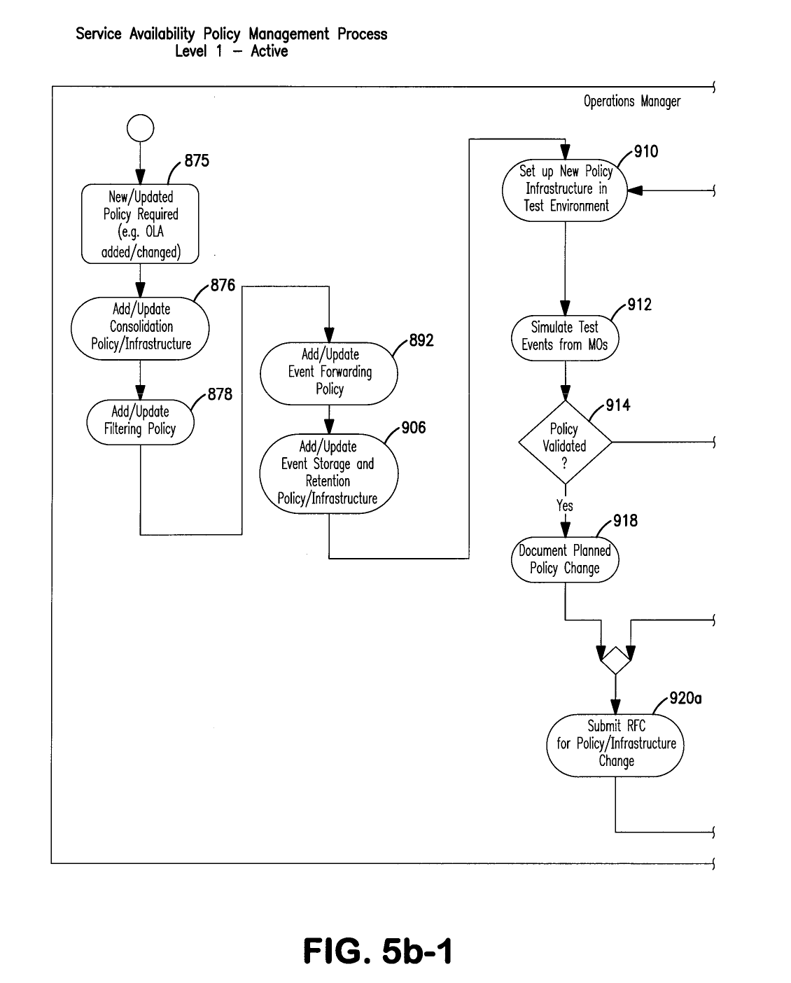

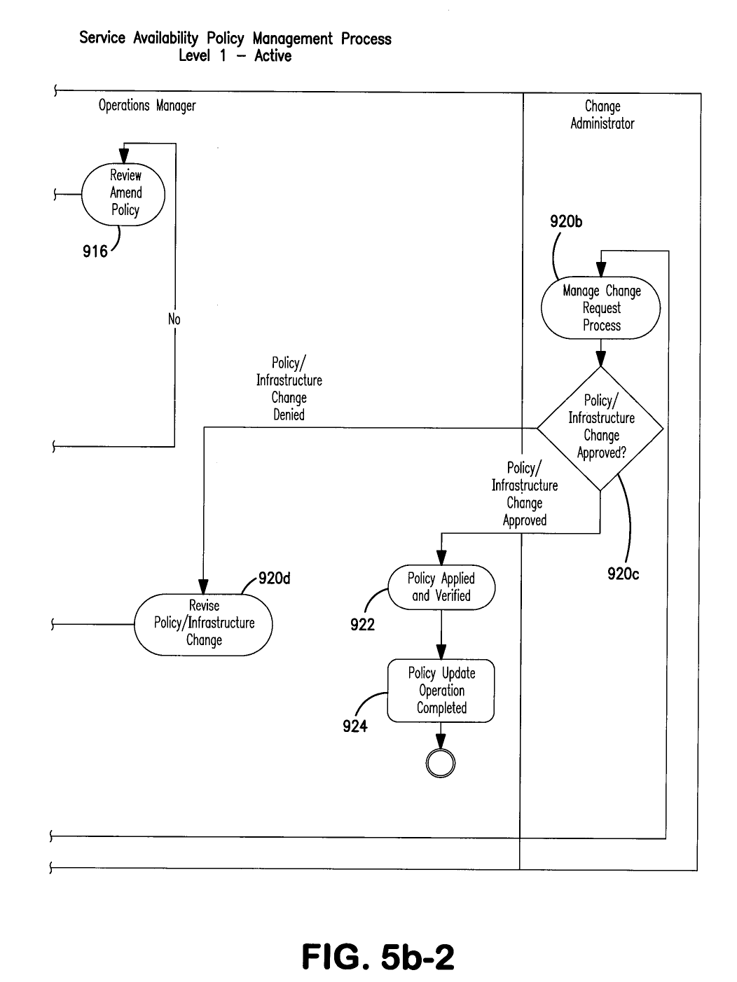

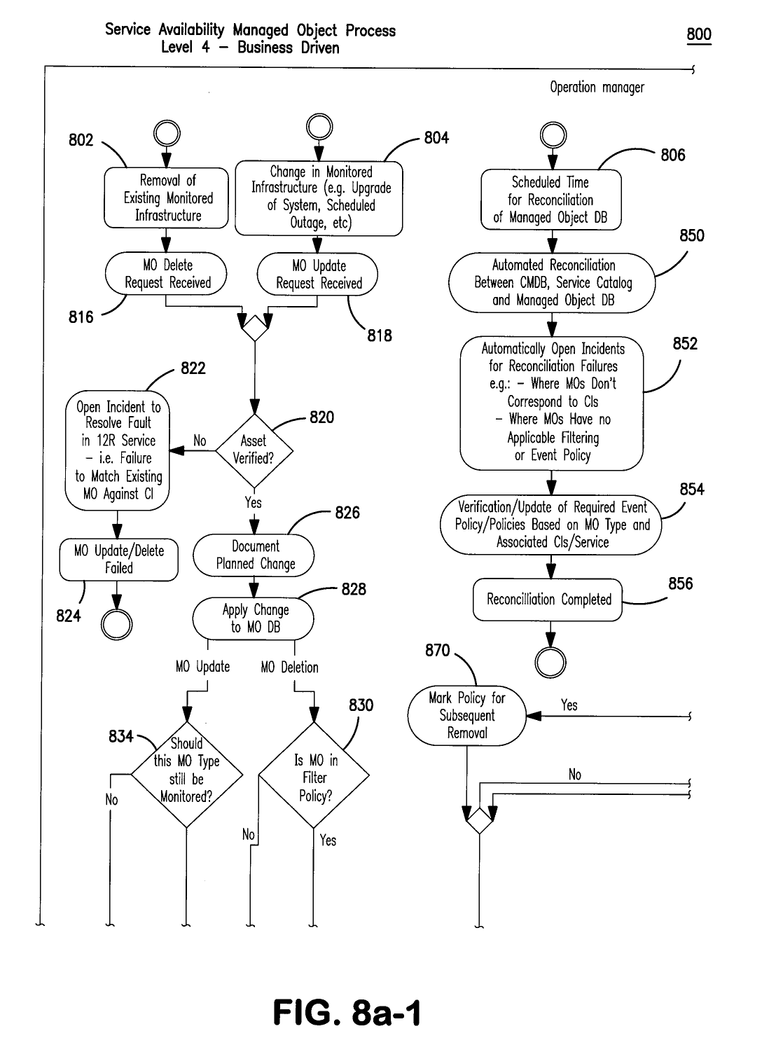

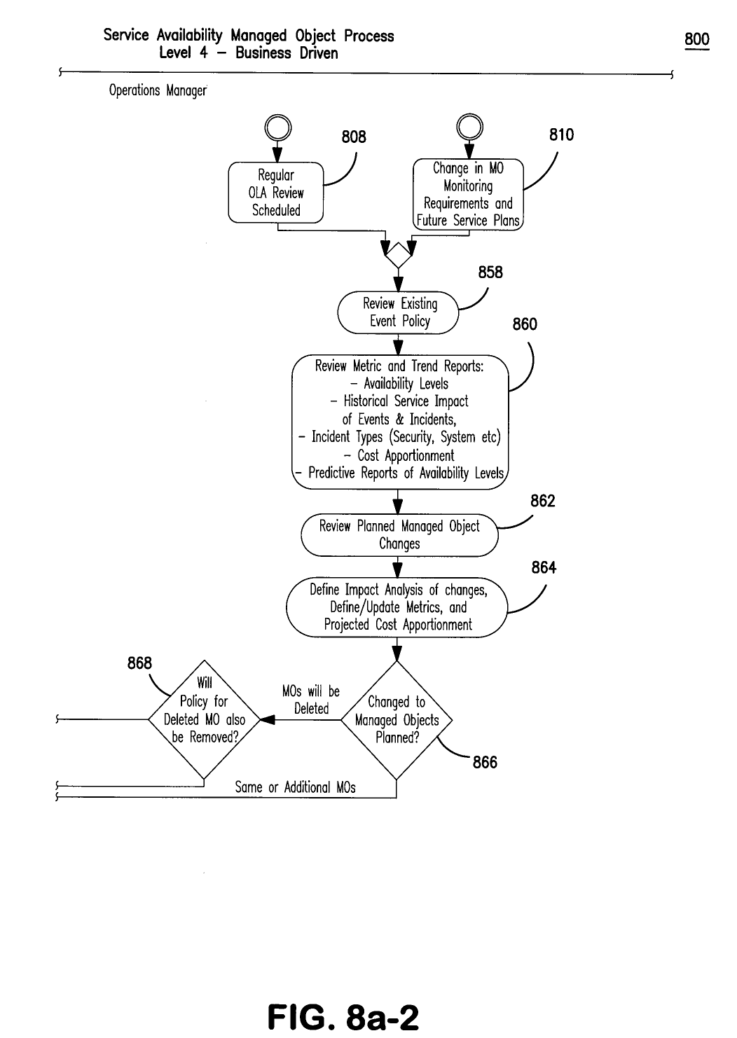

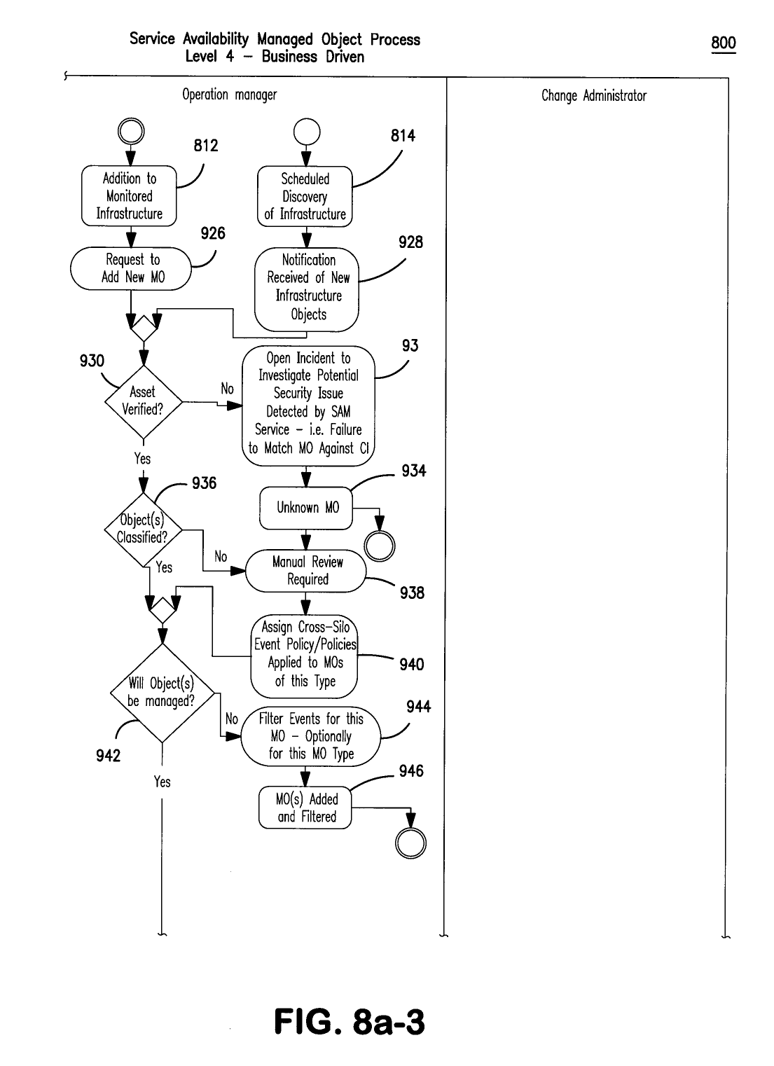

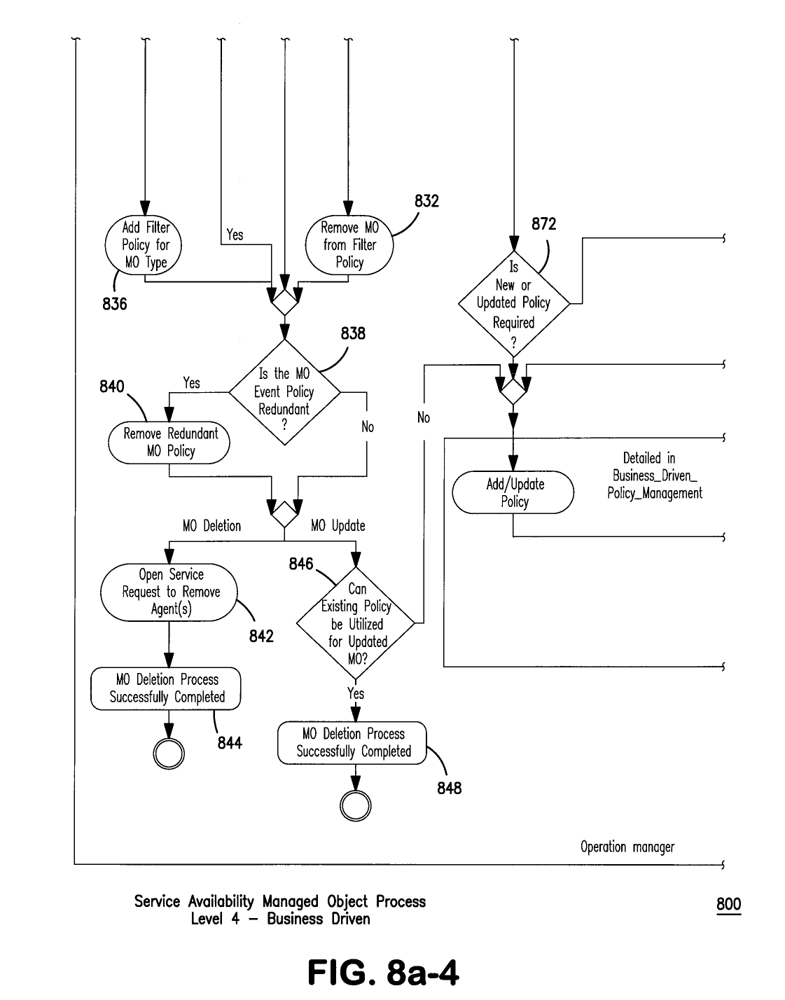

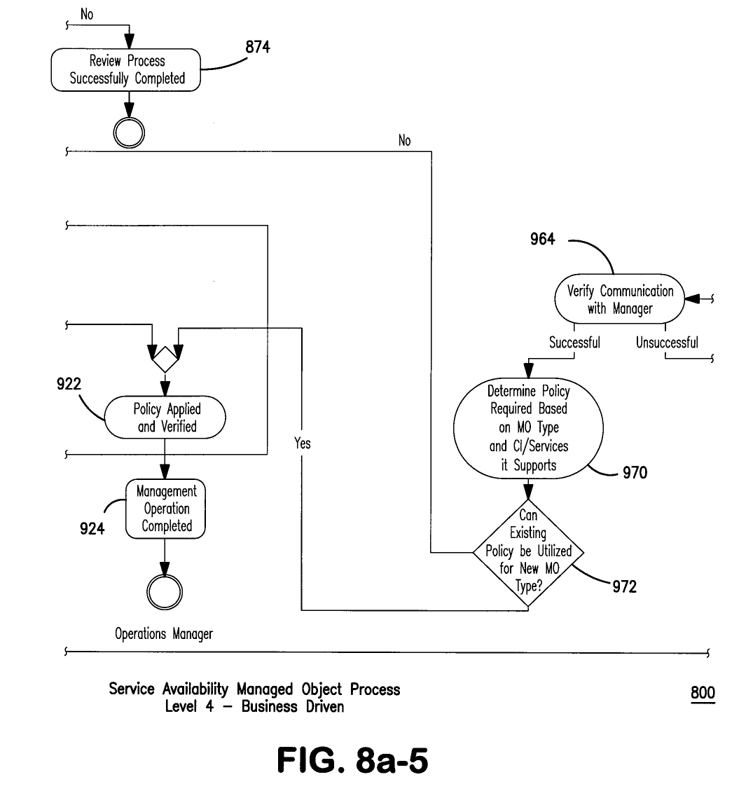

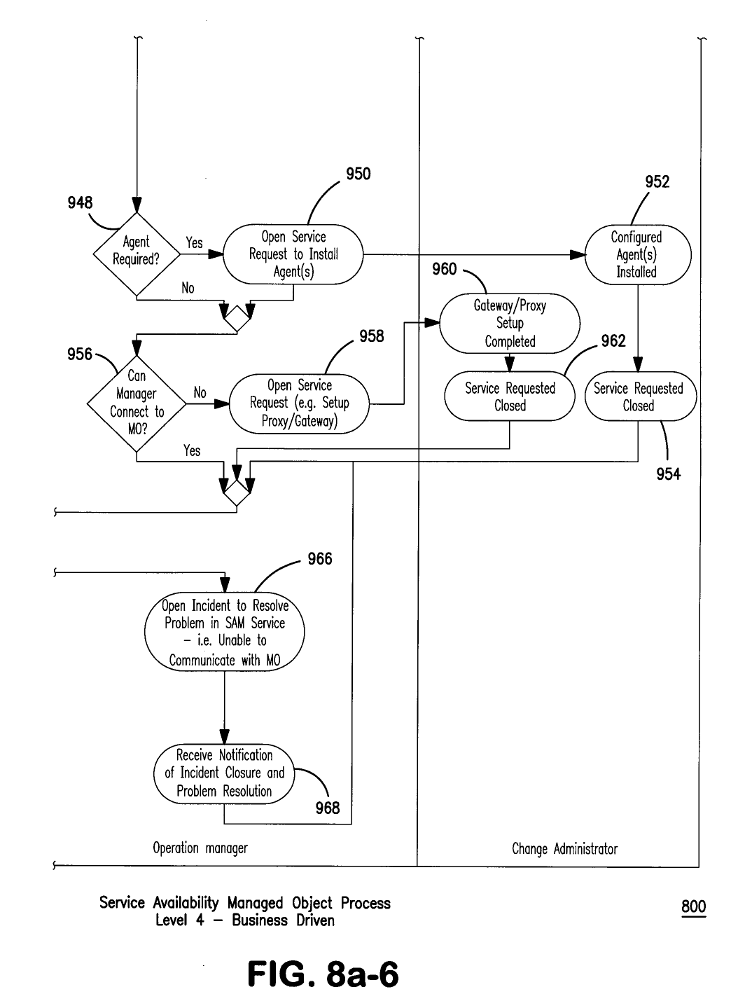

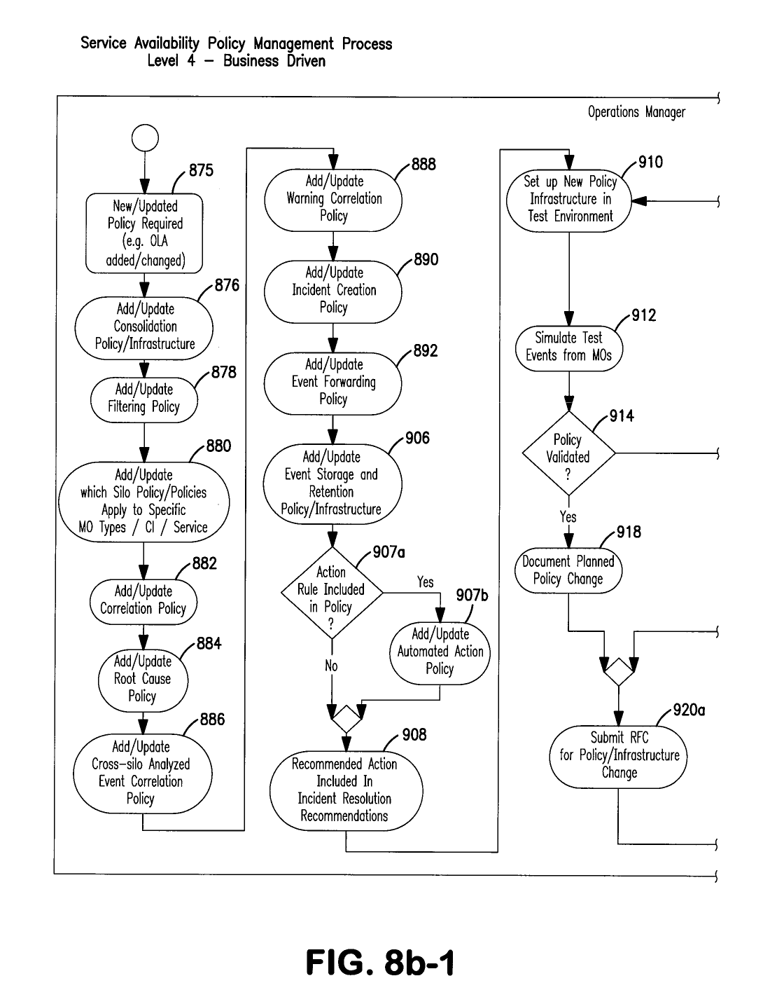

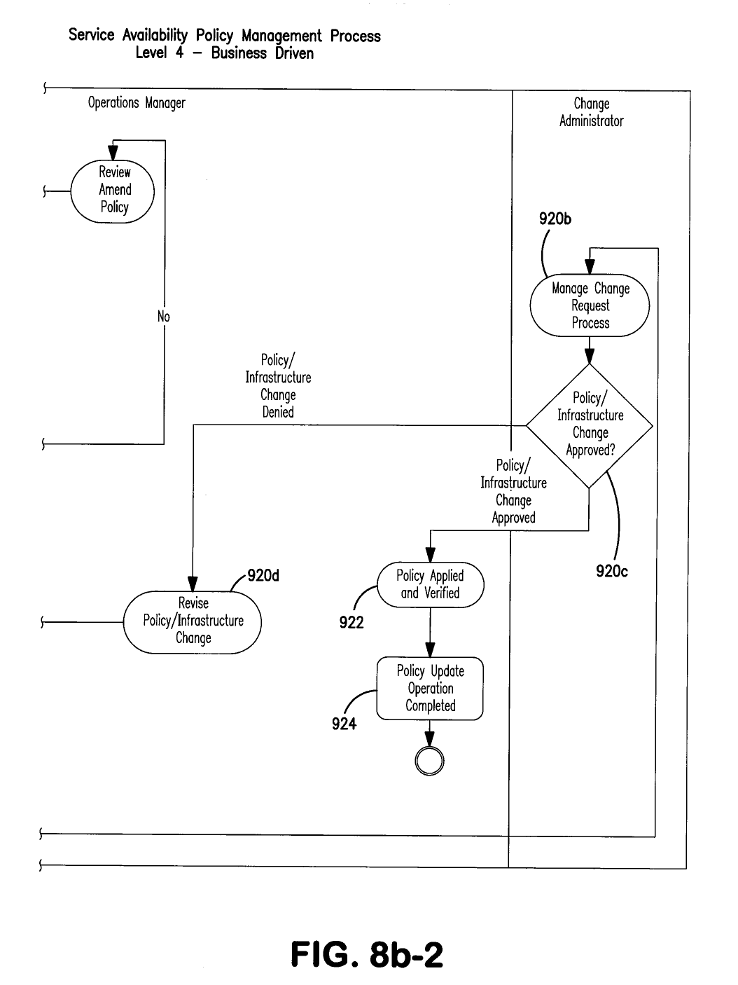

Referring to FIGS. 8a and 8b, a method 800 for managing objects according to an embodiment of the present invention, is depicted. FIGS. 5a-7b depict methods 500, 600, and 700, respectively, for managing objects according to embodiments of the present invention. Methods 500, 600, and 700 are similar to method 800, except that some of the steps from method 800 are removed from methods 500, 600, and 700. Therefore, only method 800 is described in the present application. Specifically, methods 500, 600, 700, and 800 represent different levels of managing objects, with method 500 being the least active method of managing objects, and method 800 being the most active method of managing objects. Method 800 includes seven (7) possible starting points, corresponding to steps 802-814, depending on the type of object managing the operations manager wishes to implement at a given time. Step 802 corresponds to removing existing managed objects, step 804 corresponds to updating managed objects, step 806 corresponds to reconciling the managed object database, step 808 corresponds to reviewing managed object policies, step 810 corresponds to changing managed object monitoring requirement, step 812 corresponds to adding new managed objects, and step 814 corresponds to discovering of new infrastructure objects. Moreover, because steps 802 and 804, steps 808 and 810, and steps 812 and 814 follow common paths within the flow chart of FIG. 8a, respectively, these steps are grouped together in the discussion of method 800.

When the operations manager wishes to remove an existing managed object, in step 802, an existing monitored object is selected for removal, and in step 816, a request for the removal of the selected, managed object is received. Method 800 then proceeds to step 820. When the operations manager wishes to update a managed object, in step 804, an existing monitored object is selected for updating, and in step 818, a request for the updating of the managed object is received. Method 800 then proceeds to step 820.

In step 820, it is determined whether the managed object is verified. If it is not verified, in step 822, there is a failure to match the managed object against a configuration item, and in step 824, the removal or updating of the managed object is canceled. If, however, in step 820 the managed object is verified, then in step 826 the panned change is documented, and in step 828, the changed is applied in the managed object database. If step 802 originally was selected, method 800 then proceeds to step 830, if, however, step 804 original was selected, method 800 instead proceeds to step 834.

In step 830, it is determined whether the managed object is included in the managed object filtering policy. If the managed object is not included in the managed object filtering policy, method 800 proceeds to step 838, if, however, the managed object is included in the managed object filtering policy, then in step 832, the managed object is removed from the managed object filtering policy, and method 800 proceeds to step 838.

In step 834, it is determined whether the managed object type associated with the selected managed object still should be managed. If the managed object type associated with the selected managed object still should be managed, method 800 proceeds to step 838, if, however, the managed object type associated with the selected managed object should not continue to be managed, then in step 836, a filter policy is added to the managed object, and method 800 proceeds to step 838.

In step 838, it is determined whether the managed object event policy is redundant. If the managed object event policy is redundant, then in step 840, the managed object event policy is removed. If step 802 originally was selected, method 800 then proceeds to step 842, if, however, step 804 original was selected, method 800 instead proceeds to step 846.

In step 842, a service request to remove the agent or agents associated with the managed object is sent, and in step 844, the agent or agents are removed and the managed object removal successfully is complete.

In step 846, it is determined whether the existing managed object policy may be used for the updated managed object. If the existing managed object policy may be used for the updated managed object, then in step 848 the updating of the managed object successfully is complete. If, however, the existing managed object policy may not be used for the updated managed object, method 800 proceeds to step 875.

In steps 875-892, various policies for the managed object are updated or added, and in step 906 the event storage and retention policy or infrastructure is updated. In step 907a it is determined whether an action rule is included in the policy. If the action rule is included in the policy, the automated action policy is updated, and method 800 proceeds to step 908, and if the action rule is not included in the policy, method 800 proceeds directly to step 908.

In step 908, an incident resolution is generated which recommends an action to be taken, and in step 910 the new policy infrastructure is set up in a test environment. In step 912, test events are simulated for the updated managed object, and in step 914, it is determined whether the new policy infrastructure is validated based on the test events. If the step new policy infrastructure is not validated, then in step 916, the policy infrastructure is reviewed and amended, and method 800 returns to step 910. If, how, the new policy infrastructure is validated in step 914, then the method proceeds to step 918. In step 918, the planned policy change is documented, and if applicable, the operations manager follows a configuration management processes for implementing the changes. For example, in step 920a the policy or infrastructure change is submitted to the operations manager, and in step 920a the change is processed. In step 920c it is determined whether to approve the change. If the change is not approved, method 800 proceeds to step 920d where the change is revised and method 800 then returns to step 920a. Nevertheless, if the change is approved in step 920c, method 800 proceeds to step 922. In step 922 the new policy is applied and verified, and in step 924, method 800 is complete.

When the operations manager wishes to reconcile the managed object database, in step 806, the operations manager schedules a time for reconciling the managed object database. In step 850, there is automatic reconciliation between the configuration management database, a service catalog, and the managed object database. In step 852, any incidents of reconciliation failure automatically are opened, and in step 854, event policies are updated and/or verified based on managed object type and associated configuration item. In step 856, reconciliation is complete.

When the operations manager wishes review an existing policy, in step 808, the policy for review is selected, and method 800 proceeds to step 858. When the operations manager wishes to make a change to the managed object monitoring requirements, in step 810, the policy associated with the managed object is selected, and method 800 proceeds to step 858. In step 858, the existing event policy is reviewed, and in step 860, metric and trend reports associated with the policy are reviewed. In step 862, the planned managed object changes are reviewed, and in step 864, an impact of the planned changes is defined. In step 866, it is determined what type of changes to the managed object are planned. If it is determined that the planned changes do not affect the type of the managed object, or if the planned change corresponds to additional managed objects of the same type, method 800 proceeds to step 872. If, however, it is determined that the planned changes will change the type of the managed object, then in step 868 the existing managed object is deleted/removed, and it is determined whether the policy associated with the deleted managed object also is to be deleted/removed. If the policy is not to be deleted/removed, method 800 proceeds to step 872, if, however, the policy is to be deleted/removed, and in step 870, the policy is marked for subsequent deletion/removal, and method 800 proceeds to step 872. In step 872, it is determined whether a new or updated policy is required for the managed object. If a new or updated policy is not required, then in step 874 the review process is complete. If, however, a new or updated policy is required, then method 800 proceeds to step 875, which is described above in detail.

If the operations manager wishes to add new monitored infrastructure, e.g., add a new managed object, then in step 812, the new managed object is selected, and in step 926, a request to add the new managed object is made. Method 800 then proceeds to step 930. If the operations manager wishes to schedule the discovery of managed infrastructure, in step 814, the discovery is scheduled, and in step 928, notification of the new managed objects is received. Method 800 then proceeds to step 930.

In step 930, it is determined whether the object is verified. If it is not verified, in step 932, there is a failure to match the object against a configuration item, and in step 934, method 800 is canceled. If, however, in step 930 the object is verified, then in step 936 it is determined whether the object is classified. If the object is not classified, then in step 938, manual review is required, and in step 940 an event policies or polices is assigned to objects of this type. Method 800 then proceeds to step 942. If, however, the object is classified in step 936, then method 800 proceeds to step 942.

In step 942, it is determined whether the object will be managed. If the object will not be managed, then in step 944 events for the object are filtered, and in step 946, the object is added with the filter. Method 800 then is complete. If, however, the object is to be managed in step 942, then in step 948, it is determined whether an agent is required for the object, e.g., the object may come with a pre-installed agent, such that an additional agent may not be required. If an agent is required, then in step 950, an open service require to install the agent is sent, and in step 952, the agent is installed. In step 954 the service request is closed, and method 800 proceeds to step 956. If, however, an agent is not required in step 948, then method proceeds to step 956.

In step 956, it is determined whether the operations manager is able to connect to the object to be managed. If the operations manager is able to connect to the object to be managed, method 800 proceeds to step 964. If, however, the operations manager is not able to connect to the object to be managed, then in step 958, an open service request is transmitted requesting that a gateway be setup. In step 960, the gateway setup is complete, and in step 962 the service request is closed. Method 800 then proceeds to step 964. In step 964, communication between the object to be managed and the operations manager is verified. If the verification is not successful, then in step 966 incident to resolve the problem is opened, and in step 968 a notification that the incident was closed and the problem was resolved is received. Method 800 then returns to step 964. If, however, in step 964 communication is verified, then in step 970 a policy for the object to be managed is determined based at least on the type of the object to be managed. In step 972 it is determined whether an existing policy may be used for the object to be managed. If an existing policy may be used, then method 800 proceeds to step 922, which is described above in detail. If, however, an existing policy cannot be used, then method 800 proceeds to step 876, which is described above in detail.

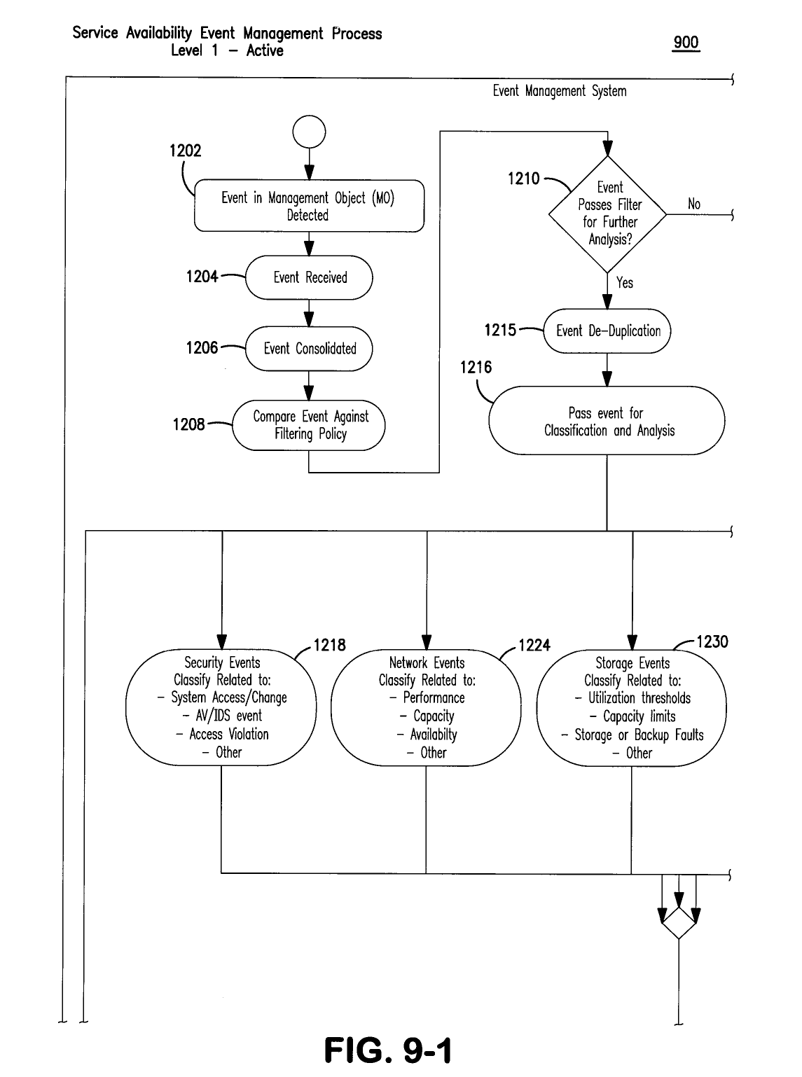

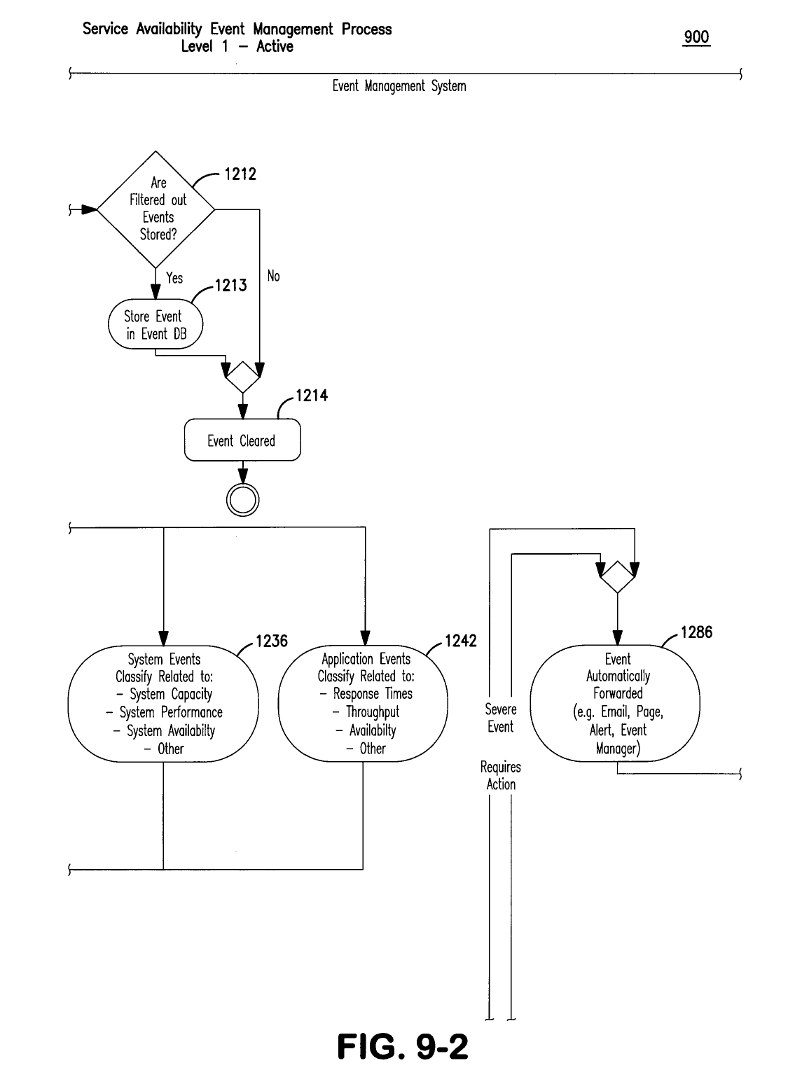

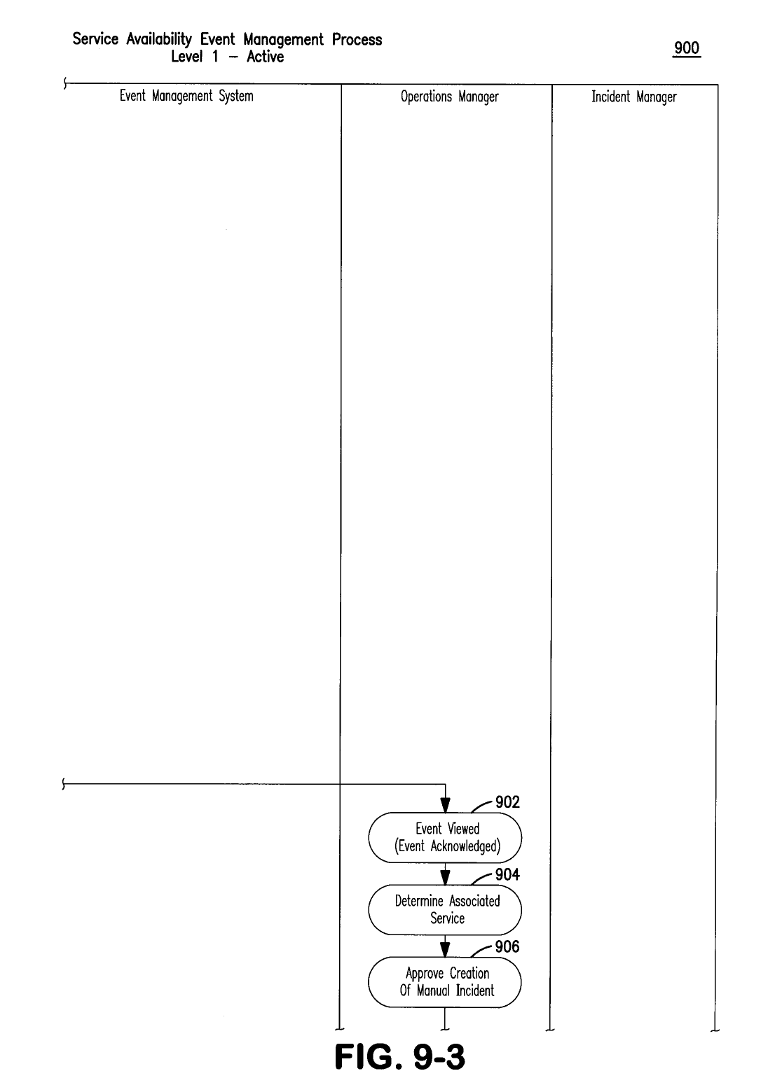

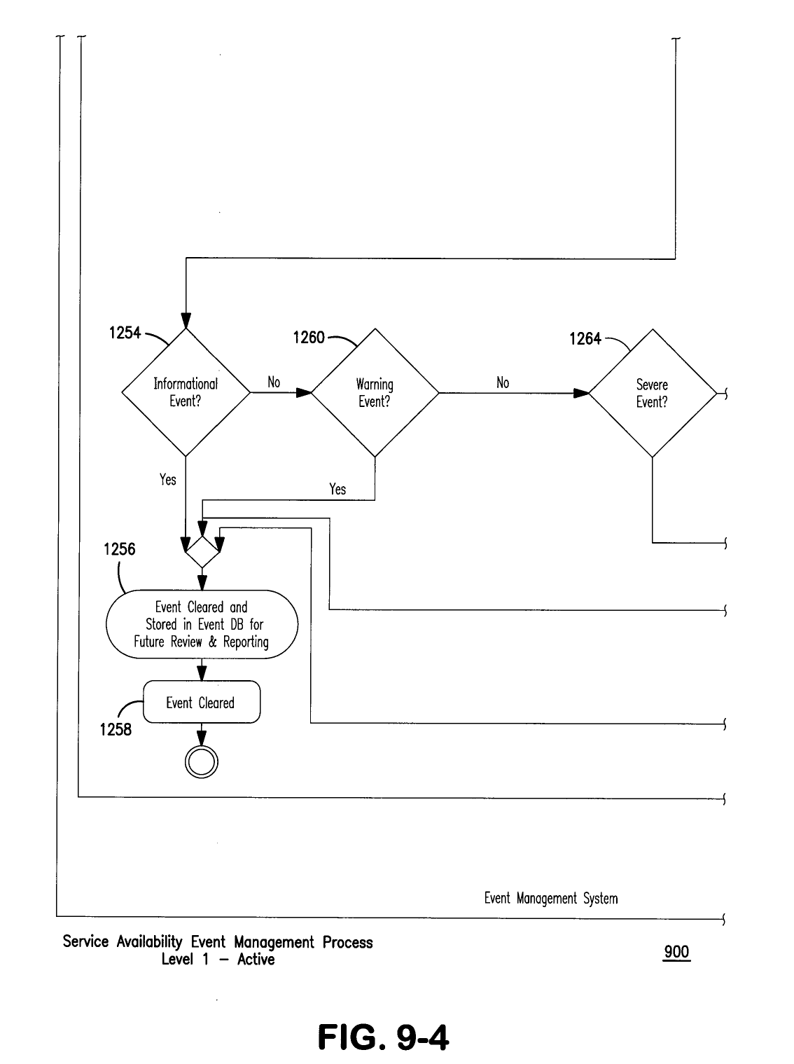

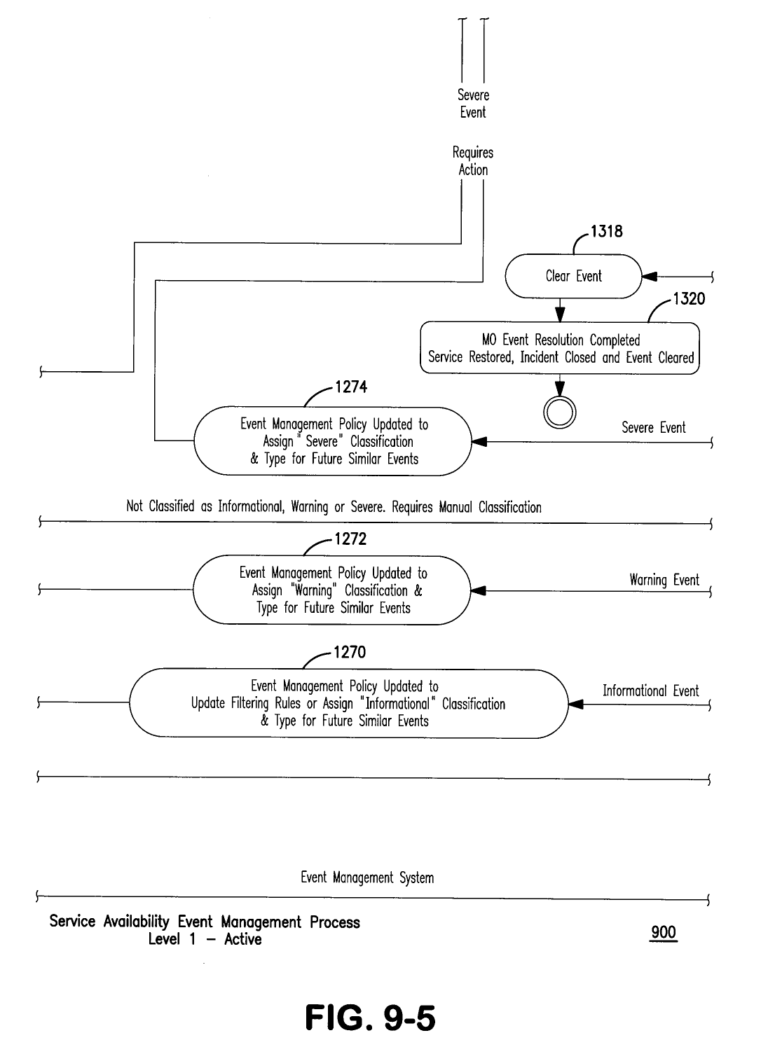

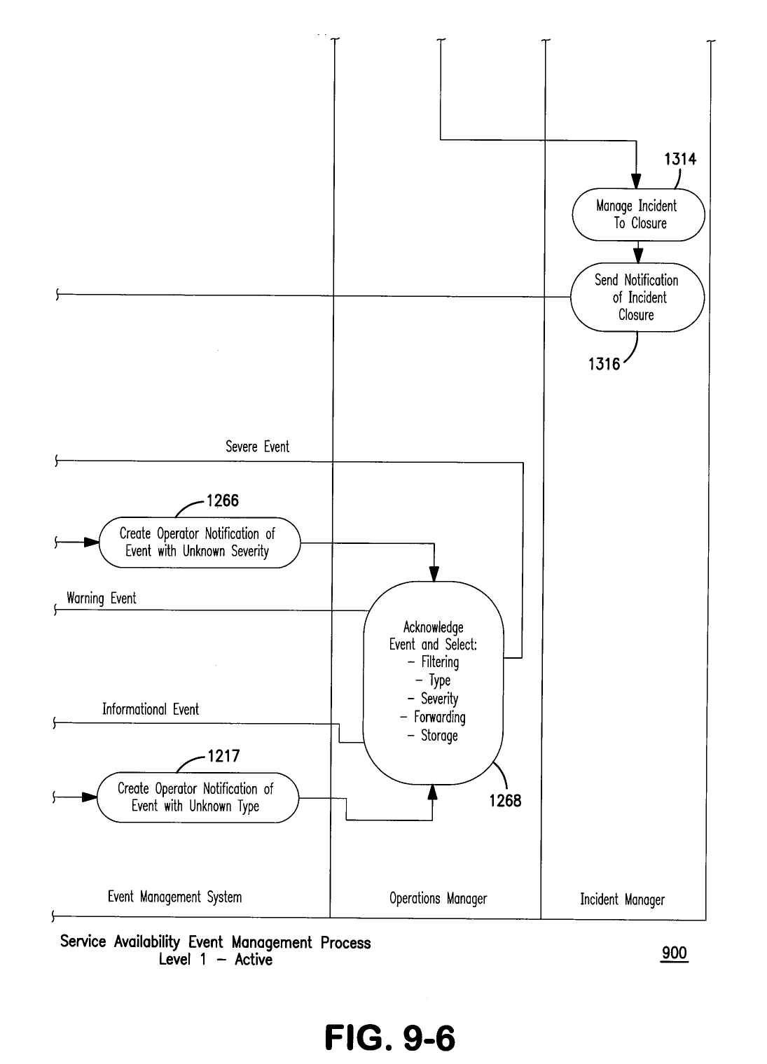

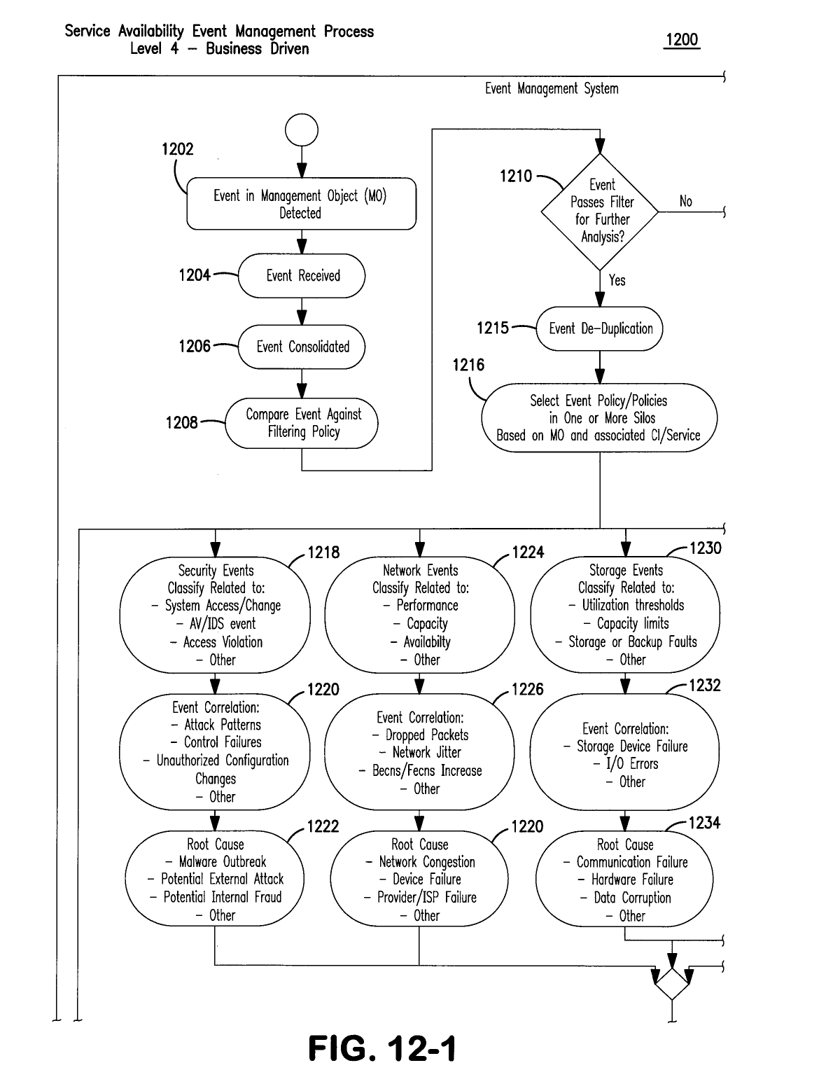

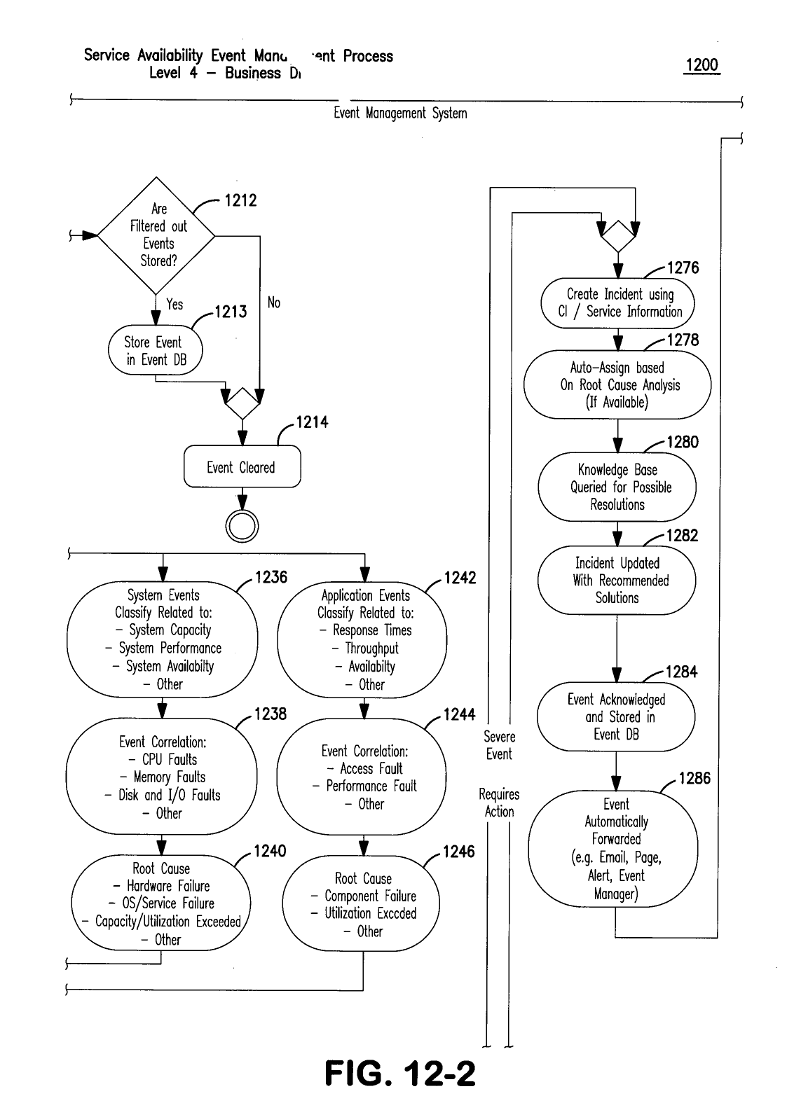

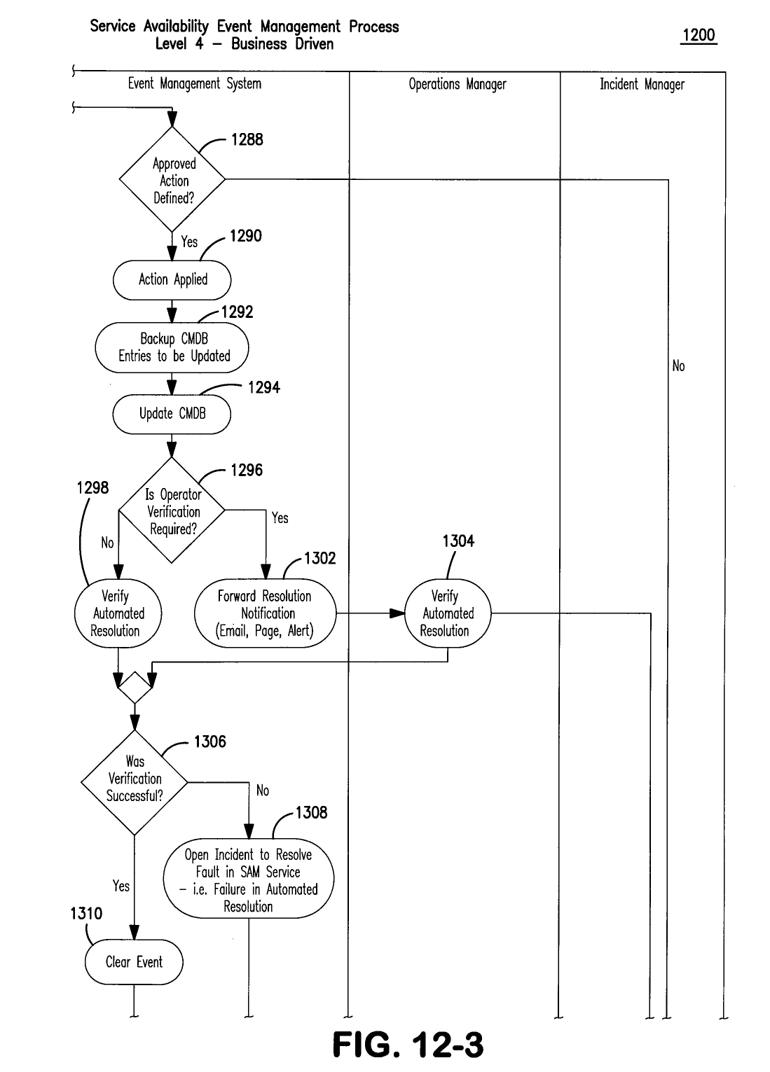

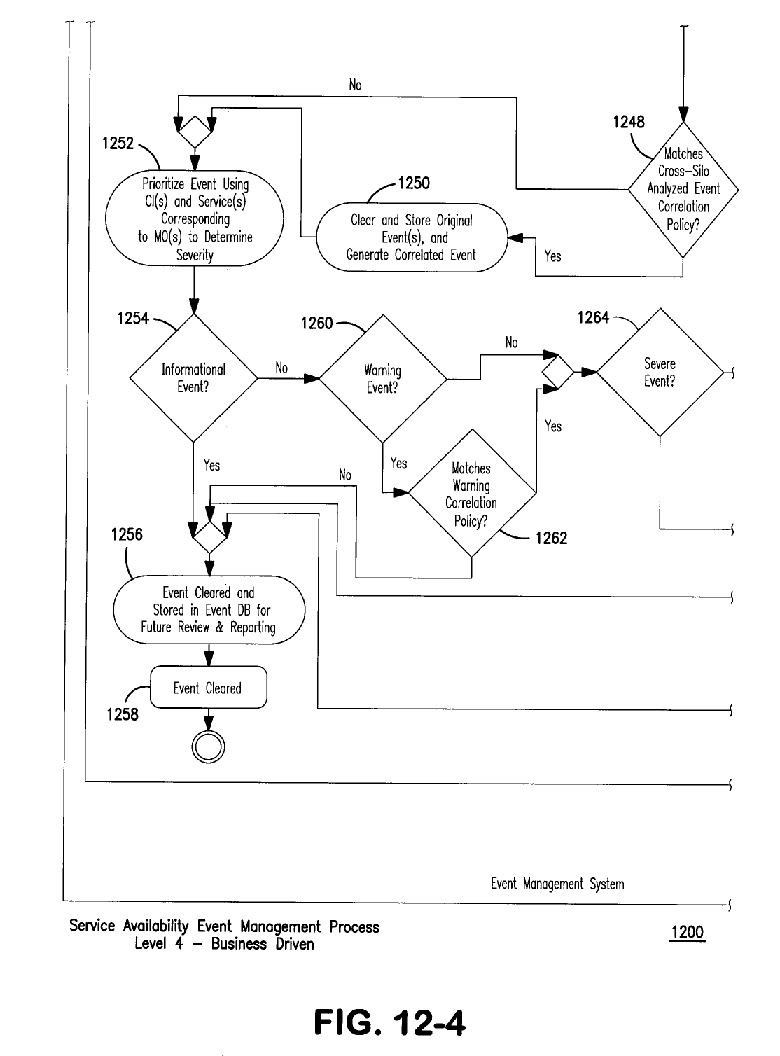

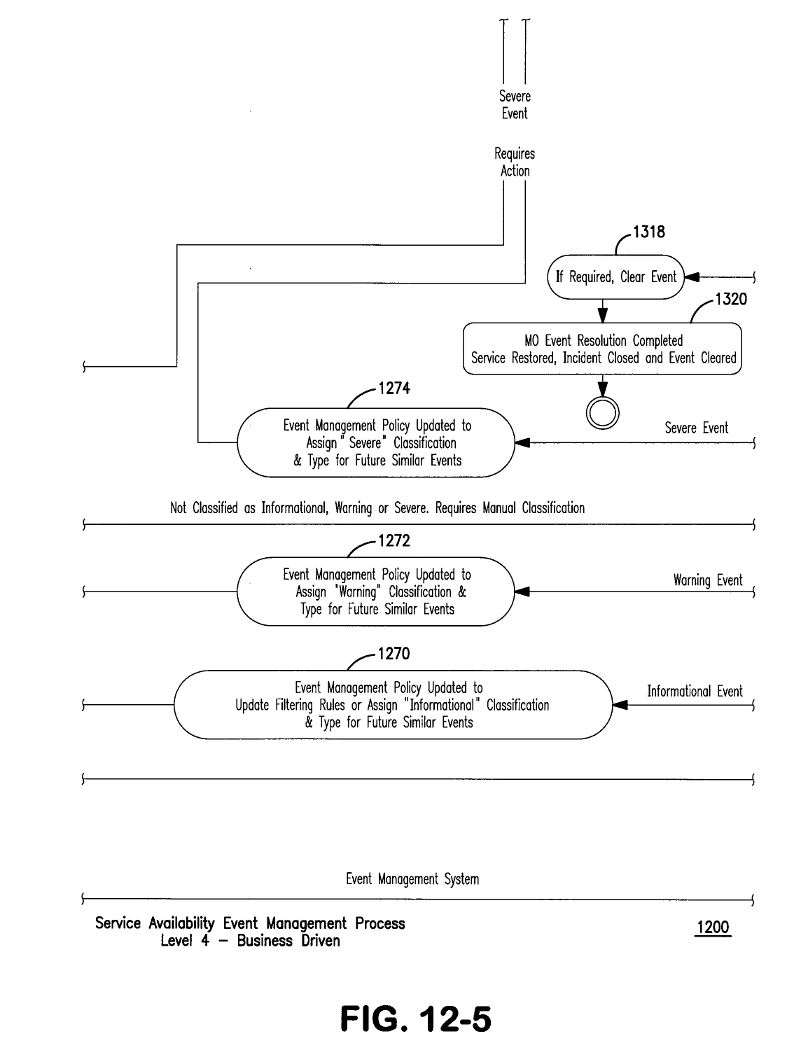

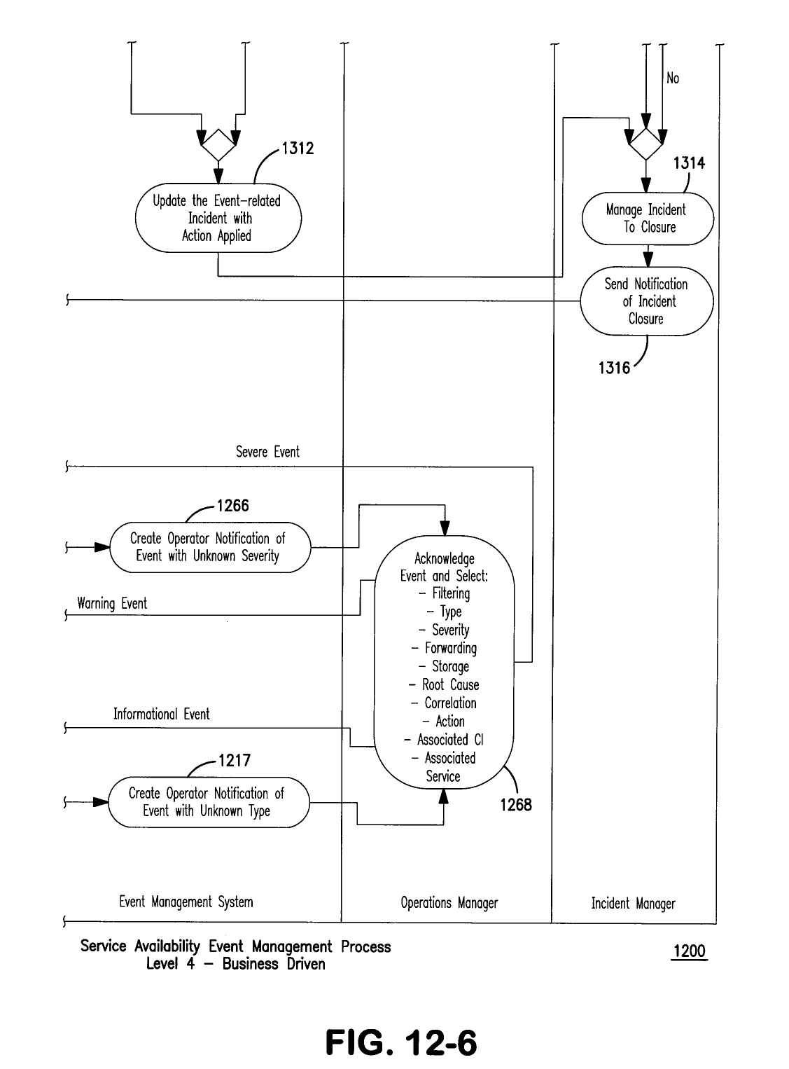

Referring to FIG. 12, a method 1200 for resolving different types of events according to an embodiment of the present invention, is depicted. FIGS. 9-11 depict methods 900, 1000, and 1100, respectively, for resolving different types of events according to embodiments of the present invention. Methods 900, 1000, and 1100 are similar to method 1200, except that some of the steps from method 1200 are removed from methods 900, 1000, and 1100. Therefore, only method 1200 is described in the present application. Specifically, methods 900, 1000, 1100, and 1200 represent different levels of resolving events, with method 900 being the least active method of resolving events, and method 1200 being the most active method of resolving events. Moreover, method 900 may be used in combination with method 500, method 1000 may be used in combination with method 600, method 1100 may be used in combination with method 700, and method 1200 may be used in combination with method 800.

Referring to FIG. 12, in step 1202, an event in the managed object database is detected, and in step 1204, information associated with the event is received. In step 1206, similar events which are received are consolidated into a single event, and in step 1208, the event is compared against the filtering policy. In step 1210, it is determined whether the event is to be filtered. In the event is to be filtered, then in step 1212, it is determined whether the filtered event is to be stored. If the filtered event is not to be stored, then in step 1214 the event is cleared. If the filtered event is to be stored, then in step 1213, the event is stored, and in step 1214, the event is cleared. If in step 1210 it is determined that the event is not to be filtered, then in step 1215 the event is de-duplicated, e.g., a redundancy with respect to step 1206. In step 1216, it is determined whether the event can be classified. If the event cannot be classified, then in step 1217, an operator notification is created that the event type is unknown, and method 1200 proceeds to step 1268 (discussed below). If, however, the event can be classified, then method 1200 proceeds to steps 1218-1222 if the event type is a security event (steps 1218-122 corresponding to a security event silo), steps 1224-1228 if the event type is a network event (steps 1224-1228 corresponding to a network event silo), steps 1230-1234 if the event type is a storage event (steps 1230-1234 corresponding to a storage event silo), steps 1236-1240 if the event type is a system event (steps 1236-1240 corresponding to a system event silo), and steps 1242-1246 if the event type is an application event (steps 1242-1246 corresponding to an application event silo). In step 1218, the event is classified as a security event, and step 1220 an event correlation is attempted to be determined by comparing the event with previous security events to determine whether there is a correlation between the events. In step 1222, the root cause of the event is attempted to be determined, e.g., based on the determination in event correlation step 1220, and method 1200 then proceeds to step 1248. Steps 1224-1228; 1230-1234; 126-1240; and 142-1246 are similar to steps 1218-1222. Therefore, these steps are not discussed in detail.

In step 1248, an event correlation is attempted to be determined by comparing the event with previous events from each of the silos to determine whether there is a correlation between the events, e.g., an event which is classified as a security event may be correlated with events that are non-security events. If there is no correlation, then method 1200 proceeds to step 1252. Nevertheless, if there is a correlation, then in step 1250, the original event is cleared and stored, and the correlated event is generated. Method 1200 then proceeds to step 1252. In step 1252, the event is prioritized to determine the severity of the event. In step 1254, it is determined whether the event is an informational event. If the event is an informational event, then in step 1256, the event is stored for future review, and in step 1258 the event is cleared. Method 1200 then is complete. If, however, in step 1254 the event is not an informational event, then in step 1260 it is determined whether the event is a warning event. If the event is a warning event, then in step 1262, it is determined whether the event matches a warning correlation policy. If the event does not match a warning correlation policy, then the event proceeds to step 1256, which is described in detail above. If the event matches a warning correlation policy, then method 1200 proceeds to step 1264. Similarly, if the event is not a warning event in step 1260, method 1200 also proceeds to step 1264.

In step 1264, it is determined whether the event is a severe event. If the event is a severe event, then method 1200 proceeds to step 1276. If it is determined that the event is not classified as a sever event, then the classification of the event is unknown, i.e., because it is not an informational event, a warning event, or a severe event, and method 1200 proceeds to step 1266. In step 1266, a notification that an event with an unknown classification was received is created and transmitted to the operations manager. In step 1268, the operations manager classifies the event. If the event is classified as an informational event, method 1200 proceeds to step 1270, if the event is classified as a warning event, method 1200 proceeds to step 1272, and if the event is classified as a severe event, method 1200 proceeds to step 1274. In step 1270, the event management policy is updated to update the filtering rules and/or assign a warning classification for future, similar events, and method 1200 proceeds to steps 1256 and 1258. In step 1272, the event management policy is updated to assign a warning classification for future, similar events, and method 1200 proceeds to steps 1256 and 1258. In step 1274, the event management policy is updated to assign a severe classification for future, similar events, and method 1200 proceeds to step 1276.

In step 1276, an incident report is created for the event, and in step 1278, the event is automatically is assigned based on the root cause of the event. In step 1280, a knowledge base is queried for possible resolutions for the event, and in step 1282, the incident report is updated based on the possible resolutions. In step 1284, the event is acknowledged and stored in the event database, and in step 1286, the event automatically is forwarded to the event manager. In step 1288 it is determined whether an approved action is defined. If there is no approved action, then method 1200 proceeds to step 1314. If, however, there is an approved action, then in step 1290, the action is applied. In step 1292 the configuration management database is backed-up, and in step 1294, the configuration management database is updated. In step 1296 it is determined whether verification by the operations manager of the resolution is required. If operations manager verification is not required, then in step 1298, the automated resolution is verified, and method 1200 proceeds to step 1306. If operations manager verification is required, then in step 1302 a resolution notification is forwarded to the operations manager, and in step 1304 the operations manger verifies the automatic resolution. Method 1200 then proceeds to step 1306.

In step 1306 it is determined whether the verification was successful. If the verification was successful, then in step 1310 the event is cleared, and in step 1312 the incident report is updated to indicate the action which was applied. Method 1200 then proceeds to step 1314. If, however, the verification was not successful in step 1306, then in step an incident report is opened to resolve the fault, and method 1200 proceeds to step 1312 and step 1314. In step 1314 an incident manager manages the incident to closure, and in step 1316, the incident manager sends a notification indicating the incident has been closed. In step 1318, the event is cleared (if required), and in step 1320, event resolution is complete.

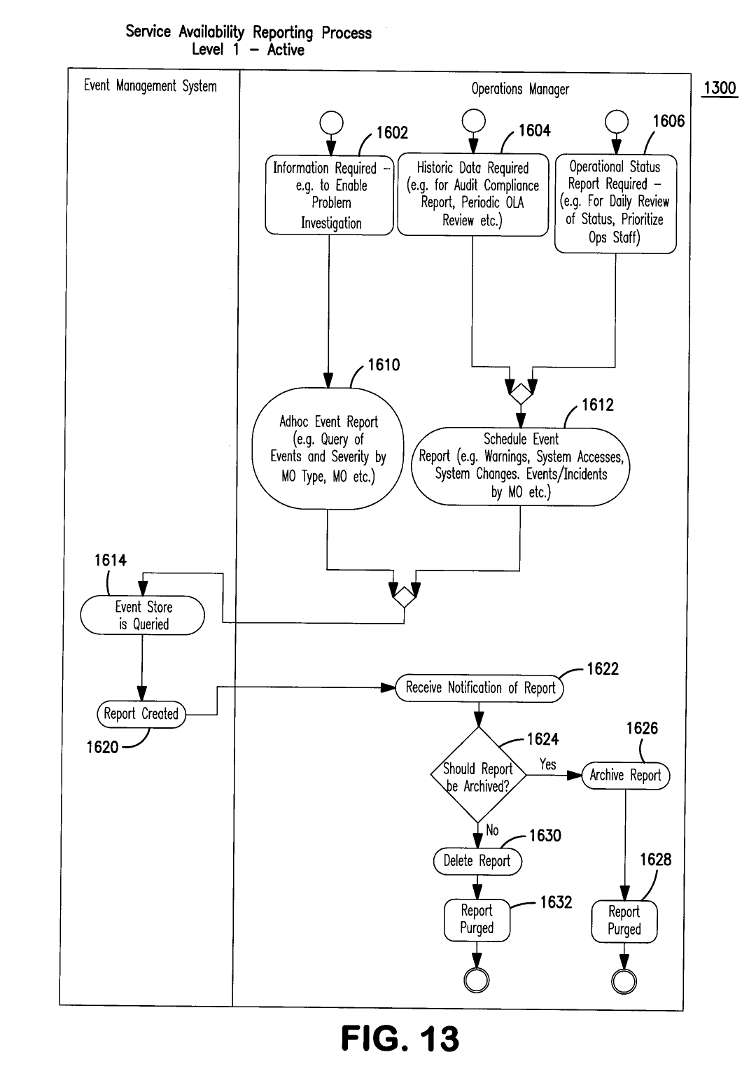

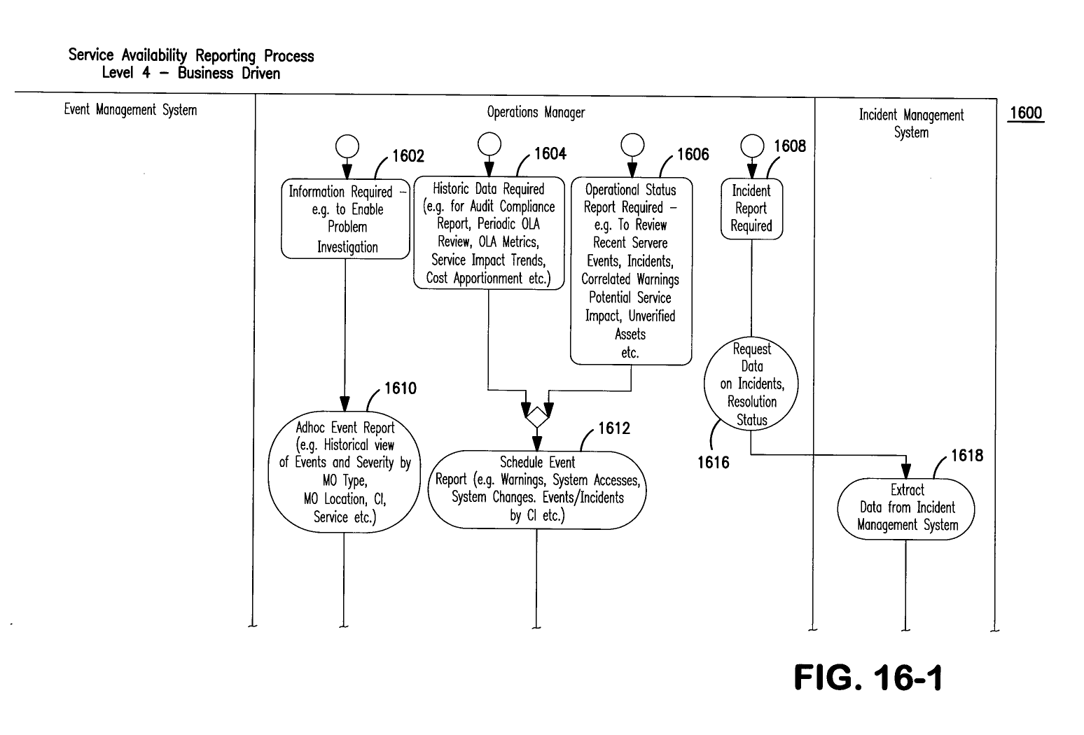

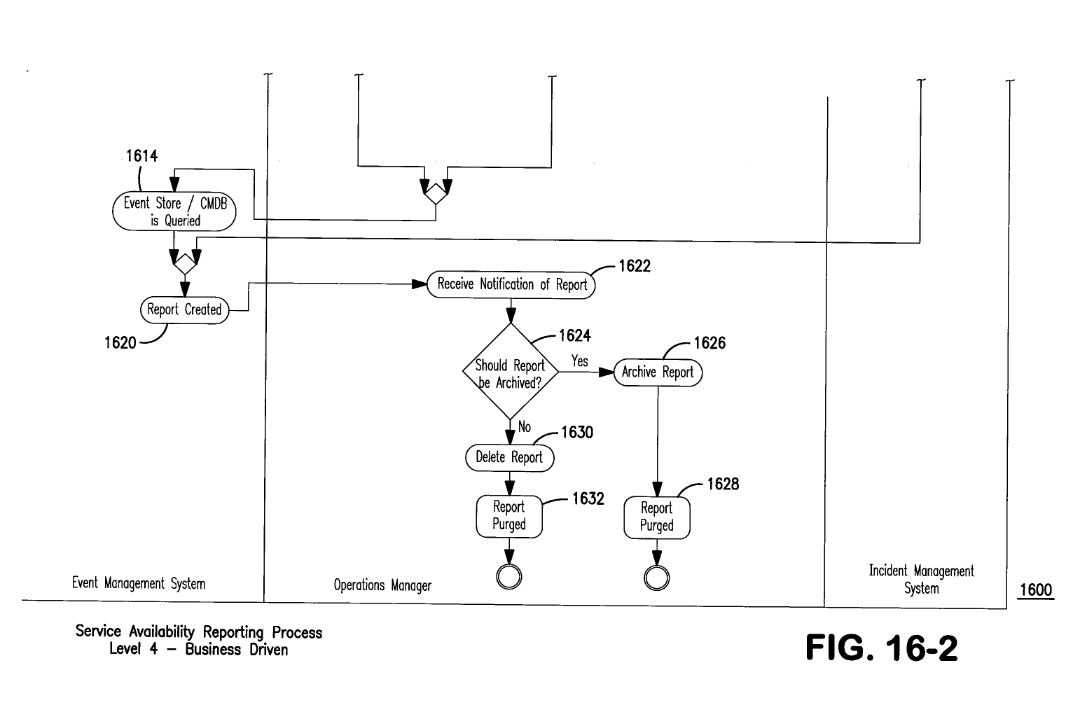

Referring to FIG. 16, a flow chart of a method 1600 for reporting data associated with managed objects and events associated with such managed objects is depicted. FIGS. 13-15 depict methods 1300, 1400, and 1500, respectively, for reporting data associated with managed objects and events associated with such managed objects according to embodiments of the present invention. Methods 1300, 1400, and 1500 are similar to method 1600. Therefore, only method 1600 is described in the present application. Specifically, methods 1300, 1400, 1500, and 1600 represent different levels of reporting data, with method 1300 being the least active method of reporting events, and method 1600 being the most active method of reporting events. Moreover, method 1300 may be used in combination with methods 500 and 900, method 1400 may be used in combination with methods 600 and 1000, method 1500 may be used in combination with methods 700 and 1100, and method 1600 may be used in combination with methods 800 and 1200.

Method 1600 includes four possible starting points, depending the type of information which the operations manager requires. Specifically, step 1602 corresponds to information required by the operations manager to investigate a problem, step 1604 corresponds to historical data, step 1606 corresponds to information associated with generating an operational status report, and step 1608 corresponds to information associated with generating an incident report. When step 1602 is selected, method 1600 proceeds to steps 1610, 1614, and 1620; when either of steps 1604 and 1606 is selected, method 1600 proceeds to steps 1612, 1614, and 1620; and when step 1608 is selected, method 1600 proceeds to steps 1616, 1618, and 1620.

After the selection of step 1602, in step 1610, an event report is created, e.g., a historical view of events and severity by managed object type and managed object location, and in step 1614, the configuration management database is queried. Method 1600 then proceeds to step 1620. After the selection of either step 1604 or 1606, in step 1612, a scheduled events report is generated, e.g., warnings, system accesses, system changes, events/incidents by configuration item, or the like, and in step 1614, the configuration management database is queried. Method 1600 then proceeds to step 1620. When step 1608 is selected, in step 1616, the operations manager requests data associated with incidents and resolution status, and in step 1618, the requested data is extracted from the incident management system. Method 1600 then proceeds to step 1620.

In step 1620, a report is created, and in step 1622, the operations manager receives notification of the report. In step 1624, it is determined whether the report should be archived. If the report is to be archived, in step 1626, the report is archived, and in step 1628, the report is saved and method 1600 is complete. If the report is not to be archived, then in step 1630 the report is deleted, and in step 1632 the report is purged and method 1600 is complete.

While the invention has been described in connection with exemplary embodiments, it will be understood by those skilled in the art that other variations and modifications of the exemplary embodiments described above may be made without departing from the scope of the invention. Other embodiments will be apparent to those skilled in the art from a consideration of the specification or practice of the invention disclosed herein. It is intended that the specification and the described examples are considered merely as exemplary of the invention, with the true scope of the invention being indicated by the flowing claims.

What is claimed is:

1. An arrangement for resolving different types of events, comprising a central system communicatively coupled to each of a plurality of lower level systems, wherein the central system is configured:
to receive information associated with a particular event from one of the plurality of lower level systems;
to determine an event type associated with the particular event; and
to determine whether the central system comprises a particular policy associated with resolving the event type associated with the particular event, wherein when the central system comprises the particular policy the central system is further configured to resolve the particular event in accordance with the particular policy, and when the central system does not comprise the particular policy the central system is further configured:
to request information associated with the particular policy;
to receive the information associated with the particular policy;
to resolve the particular event in accordance with the particular policy;
to store the particular policy in a database; and
to resolve future events that are of the event type associated with the particular type of event in accordance with the particular policy.

2. The arrangement of claim 1, wherein each of the plurality of lower level systems is selected from the group consisting of a security system, a network system, a storage system, a node system, and an application system.

3. The arrangement of claim 1, wherein the central system is further configured to filter and to store the information associated with the particular event when the particular event has a first status, and to determine whether the central system comprises the particular policy when the particular event has a second status.

4. The arrangement of claim 3, wherein the second status comprises a critical type of event, and the first status comprises a non-critical type of event.

5. The arrangement of claim 4, wherein each critical type of event and each non-critical type of event is selected by an operator of the plurality of lower level systems.

6. The arrangement of claim 1, wherein the central system is operated by a first entity, and each of the plurality of lower level systems is operated by a second entity that is different than and not associated with the first entity.

7. The arrangement of claim 1, wherein the central system is configured to determine the event type associated with the particular event based on which of the plurality of lower level systems transmits the information associated with the particular event to the central system.

8. A method for resolving different types of events, wherein a central system is communicatively coupled to each of a plurality of lower level systems, and the method comprises the steps of:
receiving information associated with a particular event from one of the plurality of lower level systems;
determining an event type associated with the particular event;
determining whether the central system comprises a particular policy associated with resolving the event type associated with the particular event;
when the central system comprises the particular policy, resolving the particular event in accordance with the particular policy; and
when the central system does not comprise the particular policy, requesting information associated with the particular policy, receiving the information associated with the particular policy, resolving the particular event in accordance with the particular policy, storing the particular policy in a database, and resolving future events that are of the event type associated with the particular type of event in accordance with the particular policy.

9. The method of claim 8, wherein each of the plurality of lower level systems is selected from the group consisting of a security system, a network system, a storage system, a node system, and an application system.

10. The method of claim 8, further comprising the step of filtering and storing the information associated with the particular event when the particular event has a first status, and wherein the step of determining whether the central system comprises the particular policy comprises the sub-step of determining whether the central system comprises the particular policy when the particular event has a second status.

11. The method of claim 10, wherein the second status comprises a critical type of event, and the first status comprises a non-critical type of event.

12. The method of claim 11, wherein each critical type of event and each non-critical type of event is selected by an operator of the plurality of lower level systems.

13. The method of claim 8, wherein the central system is operated by a first entity, and each of the plurality of lower level systems is operated by a second entity that is different than and not associated with the first entity.

14. The method of claim 8, wherein the step of determining the event type associated with the particular event comprises the sub-step of determining the event type associated with the particular event based on which of the plurality of lower level systems transmits the information associated with the particular event to the central system.

15. A software arrangement which, when executed by a processing arrangement associated with a central system communicatively coupled to each of a plurality of lower level systems, is configured to perform the steps of:
receiving information associated with a particular event from one of the plurality of lower level systems;
determining an event type associated with the particular event;
determining whether the central system comprises a particular policy associated with resolving the event type associated with the particular event;
when the central system comprises the particular policy, resolving the particular event in accordance with the particular policy or forwarding the information associated with the particular event to an operations manager system; and
when the central system does not comprise the particular policy, requesting information associated with the particular policy, receiving the information associated with the particular policy, resolving the particular event in accordance with the particular policy, storing the particular policy in a database, and resolving future events that are of the event type associated with the particular type of event in accordance with the particular policy.

16. The software arrangement of claim 15, wherein each of the plurality of lower level systems is selected from the group consisting of a security system, a network system, a storage system, a node system, and an application system.

17. The software arrangement of claim 15, wherein the software arrangement is further configured to perform the step of filtering and storing the information associated with the particular event when the particular event has a first status, and wherein the step of determining whether the central system comprises the particular policy comprises the sub-step of determining whether the central system comprises the particular policy when the particular event has a second status.

18. The software arrangement of claim 17, wherein the second status comprises a critical type of event, and the first status comprises a non-critical type of event.

19. The software arrangement of claim 18, wherein each critical type of event and each non-critical type of event is selected by an operator of the plurality of lower level systems.

20. The software arrangement of claim 15, wherein the central system is operated by a first entity, and each of the plurality of lower level systems is operated by a second entity that is different than and not associated with the first entity.

21. The software arrangement of claim 15, wherein the step of determining the event type associated with the particular event comprises the sub-step of determining the event type associated with the particular event based on which of the plurality of lower level systems transmits the information associated with the particular event to the central system.

22. An arrangement for managing objects and for resolving different types of events associated with the objects, comprising:
an operations management system configured:
to select a particular object to be managed by the arrangement;
to determine an object type associated with the particular object;
to associate an event selection policy with the particular object based at least on the object type associated with the particular object, wherein the event selection policy indicates at least one event type that is associated with the particular object;
to selectively associate an agent with the particular object, wherein the agent is associated with one of a plurality of lower level systems; and
a central system communicatively coupled to the operations management system and to each of the plurality of lower level systems, wherein the central system is configured:
to receive information associated with a particular event from one of the plurality of lower level systems, wherein the particular event originates from the particular object;
to determine an event type associated with the particular event; and
to determine whether the central system comprises a particular policy associated with resolving the event type associated with the particular event, wherein when the central system comprises the particular policy the central system is further configured to resolve the particular event in accordance with the particular policy, and when the central system does not comprise the particular policy the central system is further configured:
to request information associated with the particular policy;
to receive the information associated with the particular policy;
to resolve the particular event in accordance with the particular policy;
to store the particular policy in a database; and
to resolve future events that are of the event type associated with the particular type of event in accordance with the particular policy.

23. The arrangement of claim 22, wherein each of the plurality of lower level systems is selected from the group consisting of a security system, a network system, a storage system, a node system, and an application system.

24. The arrangement of claim 22, wherein the central system is configured to determine the event type associated with the particular event based on which of the plurality of lower level systems transmits the information associated with the particular event to the central system.

25. The arrangement of claim 22, wherein the operations management system is further configured:
to selectively review the event selection policy; and
to selectively alter the event selection policy.

26. A method for managing objects and for resolving different types of events associated with the objects, wherein a central system is communicatively coupled to an operations managing system and each of a plurality of lower level systems, the method comprising the steps of:
selecting a particular object to be managed by the arrangement;
determining an object type associated with the particular object;
associating an event selection policy with the particular object based at least on the object type associated with the particular object, wherein the event selection policy indicates at least one event type that is associated with the particular object;
selectively associating an agent with the particular object, wherein the agent is associated with one of a plurality of lower level systems;
receiving information associated with a particular event from one of the plurality of lower level systems, wherein the particular event originates from the particular object;
determining an event type associated with the particular event;
determining whether the central system comprises a particular policy associated with resolving the event type associated with the particular event;
when the central system comprises the particular policy, resolving the particular event in accordance with the particular policy; and
when the central system does not comprise the particular policy, requesting information associated with the particular policy, receiving the information associated with the particular policy, resolving the particular event in accordance with the particular policy, storing the particular policy in a database, and resolving future events that are of the event type associated with the particular type of event in accordance with the particular policy.

27. The method of claim 26, wherein each of the plurality of lower level systems is selected from the group consisting of a security system, a network system, a storage system, a node system, and an application system.

28. The method of claim 26, wherein the step of determining the event type associated with the particular event comprises the sub step of determining the event type associated with the particular event based on which of the plurality of lower level systems transmits the information associated with the particular event to the central system.

29. The method of claim 26, further comprising the steps of:
selectively reviewing the event selection policy; and
selectively altering the event selection policy.
